(19) United States
(12) Patent Application Publication
(10) Pub. No.: US 2024/0260587 A1
(43) Pub. Date: Aug. 8, 2024

(54) METHOD FOR THE COMBINED CONTINUOUS MIXING AND METERING OF DOUGHS OR PASTES ENRICHED WITH GAS UNDER STATIC PRESSURE, CONTROL AND/OR REGULATING DEVICE FOR CARRYING OUT SUCH A METHOD, DEVICE FOR CARRYING OUT THE METHOD AND PRODUCTS OBTAINED BY THIS METHOD, AND USE OF SUCH PRODUCTS

(71) Applicants: Erich WINDHAB, Hemishofen (CH); Roland Murten AG, Murten (CH)

(72) Inventors: Erich WINDHAB, Hemishofen (CH); Joel ZINK, Zurich (CH); Daniel KIECHL, Oberengstringen (CH)

(21) Appl. No.: 18/419,252

(22) Filed: Jan. 22, 2024

(30) Foreign Application Priority Data
Feb. 7, 2023 (EP) 23000018.4

(51) Int. Cl. A21C 1/10; A21C 1/00; A21C 1/06; A21C 1/14; A21D 2/18; A21D 2/26; A21D 8/02; A21D 13/066; A21D 13/50

(52) U.S. Cl. CPC A21C 1/10; A21C 1/006; A21C 1/065; A21C 1/1405; A21C 1/1425; A21C 1/144; A21C 1/146; A21D 2/186; A21D 2/264; A21D 8/025; A21D 13/066; A21D 13/50

(57) ABSTRACT

The invention relates to a method, a control and/or regulating device, a device and products as well as the use of such products. It is shown how gas-foamed products are manufactured from doughs or from pastes in an elongated process space and how the static pressure required for the gas dissolution is maintained in the process space up to the outlet opening and the foaming in the dough or in the paste is not initiated in a targeted manner under predetermined process conditions until the product exits from a metering valve device connected downstream of the process space and the pressure is reduced.

### CROSS-REFERENCE TO RELATED APPLICATIONS

This application claims priority to European Patent Application Serial Number EP23000018.4, filed Feb. 7, 2023, which is herein incorporated by reference.

### FIELD OF TECHNOLOGY

The invention relates to a method for the coupled mixing and metering of foamed doughs or pastes for the manufacturing of food, preferably baked goods.

The invention, moreover, relates to a control and/or regulating device for a method for the coupled mixing and metering of baked goods from foamed doughs or pastes.

The invention, moreover, relates to a device for carrying out the method according to the invention.

The invention, moreover, relates to products manufactured using the method according to the invention.

Finally, the invention relates to the use of such foamed, dough- or paste-based products which have been manufactured using the method according to the invention.

### BACKGROUND

Conventionally, baked goods obtain their typical foam/sponge-like structure through the formation of steam bubbles during a baking process, wherein water-steam bubbles preferably nucleate on microgas bubbles entrapped in advance or formed by fermentation and are enlarged by progressive water vapor formation as a result of thermal energy input and, at the same time, solidification of the foam structure of the dough takes place by protein denaturation and partial drying.

In a plurality of baked goods, foam formation during the baking process is enhanced by the addition of leavening agents (most frequently sodium hydrogen carbonate or potassium hydrogen carbonate). This also applies to the use of baker's yeast, which, through the fermentation process, generates CO₂ in doughs even before the baking process and thus, in particular, improves, nucleates and supports the further formation of foam by water vapor in the baking process.

Traditionally, there is no control of the foam structure of the baked product that forms in the baking process, whereby there are fluctuations in the recipe composition and in the process parameters which have an effect on the resulting foam bubble size distribution, with potentially markedly irregular and in some cases oversized gas inclusions. This is all the more true if certain recipe components, such as cereal proteins, in particular gluten, are to be excluded from use in so-called gluten-free baked goods due to their allergenic potential. The absence of the highly elastic cereal protein leads to the restricted formation of a protein network during dough formation and its supportive improvement in stability during the baking process. As a consequence, gas/water vapor bubbles coalesce, and thereby allow significantly enlarged gas bubbles or alternatively undesirable gas inclusions to come about in the baked product. The absence of the framework protein moreover leads to a “degassing” of the product into the environment and thereby to what, as a rule, is a generally significant loss in volume of the resulting baked product. A market trend has also developed for so-called gluten-free baked goods, which are important for approximately 1.5% to 2% of the Central European and North American population as a result of an allergic reaction to gluten (celiac disease), inasmuch as, depending on the region, more than 20% of the population suffer gluten intolerance to varying degrees in foamed doughs or pastes. As a result, the development of gluten-free products became a market-relevant development trend in the baked goods sector starting as early as the end of the 1980s. This led to the patenting, in particular of recipes for baked goods, which replaced the long-chain network-forming cereal adhering protein (gluten) with mixtures of other plant proteins and/or polysaccharide mixtures, with the outcome being that most resulted in long ingredient lists with many additives/1-4/.

In this context, new methods were also developed, which implemented the active introduction of gas fractions into baked goods by means of physical methods (for example, high-pressure foaming methods) and downstream dough expansion under supercritical or alternatively subcritical gaseous state conditions/5-14/.

The foaming methods for dough systems described until today in literature (including in patent literature) all have in common that the foam is generated either by gas dispersion or by gas dissolution with downstream gas bubble expansion in process spaces/apparatuses, from which, after foam formation, the foam is transported, if necessary via a metering device, into the atmospheric environment for the purpose of filling into containers and/or for forming, for example, on conveyor belts. During the foam transport that hereby takes place through pipelines during the conveyance to the metering devices or alternatively through valves in these metering devices, as a rule, the foam structure produced is subjected to a pronounced shear stress. This often leads to damage of the foam structure by foam lamella breakage and coalescence of foam bubbles to larger gas cells. Such foam bubble enlargements bring about structural instabilities in the resulting foam products. These instabilities result in volume loss and structural defects in downstream treatment processes (for example, shaping and baking processes)/14-18/.

The larger the original gas bubbles are directly after their formation in the foaming process, the more pronounced the development of structural defects will be. Typically, dispersion processes, which allow larger gas components in fluids to be divided into smaller gas bubbles by imposing dispersion flows, result in less finely dispersed foam structures than can preferably be achieved by as complete a solution of the gas as possible with downstream renucleation of microgas bubbles by means of pressure reduction via heterogeneous nucleation, provided a sufficiently high-number density of gas bubble nucleators is available/19/.

WO 2017/081271 A1 describes a possible way of generating gas bubbles that are as small as possible with a narrow gas bubble size distribution after gas dissolution and defined pressure relief and of stabilizing them as quickly as possible with a downstream heating process (baking process) by protein denaturation. The foam generated in this process nevertheless remains exposed to pronounced flow forces in its feed flow to a metering unit as well as in the flow through the metering valve acting in this unit, and thereby suffers a coarsening and irregularization of the gas bubble size distribution until it enters a baking mold or alternatively is formed on a baking conveyor belt. Up to now, no possibility has been described to control and adjust the extensive to complete gas dissolution in the dough matrix or alternatively in the fluid fraction contained in the dough matrix (as a rule an aqueous continuous fluid phase) in a coupled mixing and metering process for food systems produced from foamed dough systems.

The increasing popularity of high-protein diets has significantly increased the demand for high-protein yet low-carbohydrate foods, especially baked goods, which until now have contained a significant carbohydrate content. Therefore, numerous developments have been undertaken to reduce the carbohydrate content in such baked products by replacing flour in the product recipe with a protein source. Whereas this approach has largely solved the problem of providing a high-protein, low-carbohydrate product in terms of recipe adaptation, the resulting products generally do not have the dough handling properties, the baking volume, crumb structure, the texture or the taste of a corresponding traditional baked product, which has significantly limited their market success to date.

The U.S. Nutrition Labelling and Education Act (NLEA) of 1990 allows “high protein” nutrient content claims on food labels/20/. The FDA approves this claim when 20% or more of the Daily Value (DV) of protein is found in the Reference Amount Customarily Consumed (RACC)/21/. Based on a 2000-calorie diet, the DV of protein is 50 grams per day/22/.

According to the FDA, the Reference Amounts Customarily Consumed (RACC) for baked goods per consumption lie in the range from about 50 g for breads, croissants, light cakes, or soft pretzels up to about 110 g for toast, muffins, crepes, or vegetable pies/23/.

There is therefore an increasing demand for baked goods that, on the one hand, are gluten-free and, on the other hand, have a high vegetable protein content and low carbohydrate content, as well as contemporaneously comprehensively fulfilling the typical quality criteria of comparable traditional baked goods. These quality criteria relate to (i) dough handling/workability, (ii) baking volume, (iii) crumb structure/texture and (iv) taste/aroma properties.

Against this backdrop, there is a need to provide a technology that allows these requirements to be fulfilled in an improved manner.

An increased content of plant proteins with a simultaneously reduced carbohydrate content is nutritionally preferred and economically relevant in view of the permanently increasing consumer demand for food products rich in plant proteins. Preferred plant protein sources according to the invention are peas and other leguminous proteins (for example, soybean, lupin, field bean), non-gluten-containing cereals (for example, oats) as well as algae and insect proteins. In the case of protein contents of up to 50% (W/W) (in relation to dry mass), increasingly demanding requirements result for the manufacturing process, in particular in order to achieve an optimum baking volume with connected minimal losses of enclosed gas bubbles and a homogeneous, narrow size distribution of the latter.

High contents of plant proteins other than gluten can adversely affect product taste as well as result in unacceptable volume and crumb structure properties when using traditional technology.

It is therefore desirable to provide a method for the manufacture of high-protein, low-carbohydrate and gluten-free baked products, with which it is possible to controllably adjust the quality characteristics of traditional baked products in terms of dough handling, workability, baking volume, crumb structure/texture and flavor properties.

### SUMMARY

The invention is based on the task of providing a continuous method for the coupled mixing and metering of dough or paste mixed with gas under elevated static pressure for the manufacture of gluten-free baked goods with a controlled degree of foaming and foam structure and with a predetermined vegetable protein content.

In addition, the invention is based on the task of providing a control and/or regulating device for such a method.

Furthermore, the invention is based on the task of providing a device for carrying out the method according to the invention.

Moreover, the invention is based on the task of providing products with an adjusted degree of foaming and foam structure.

Finally, the invention is based on the task of providing a suitable use for products manufactured according to the method of the invention.

### Solution of the Task Relating to the Method

According to an embodiment of the present disclosure, a method is provided for the combined, continuous mixing and metering of doughs or pastes enriched with gas under static pressure for the manufacture of foamed products, in particular baked goods, preferably gluten-free baked goods, in which a free-flowing or pourable, dry powder mixture for doughs or pastes with a vegetable protein content in the range from 5 to 70% (W/W), based on the dry substance, is introduced into an elongated process space of a motor-driven extruder in which:
(i) fluid is added by a fluid supply device-1 for the manufacture of a high viscosity dough or a high-viscosity paste and thereby a dough or paste plug that builds up continuously which seals against backflow effects of fluid or gas,
(ii) the viscosity of the high-viscosity dough or paste plug is significantly reduced by metering an additional fluid component fraction at at least one further fluid supply point which is spaced apart in the conveying direction from the first fluid supply device-1,
(iii) whereinafter a gas component under pressure is supplied and finely dispersed and/or dissolved in the dough or paste fluid phase by a compressed gas supply device arranged in an axial conveying direction, and
(iv) wherein at least one dough or paste discharge and metering element configured as a metering valve device is arranged on the discharge side of the processing space configured as a process space,
(v) the outlet opening of which is regulated or controlled in its cross-section in order to maintain the static pressure required for the gas dissolution in the process space, and wherein
(vi) a measuring device continuously measures the degree of gas dissolution between the compressed gas supply device and the metering valve device,
(vii) and due to a pressure control, the gas contained in the dough or paste is kept in solution or fine dispersion until the end of the metering valve device and the foam formation is launched under pressure, lowering only when exiting a valve outlet channel of the metering valve device supported by starch particles, which particles initiate a secondary, heterogeneous gas bubble nucleation, and
(viii) wherein the subsequent dough or paste foam expansion of at least ≥20%, preferably ≥50%, supported by the adjusted dough or paste viscosity, occurs only after the dough or paste exits the metering valve device.

### Certain Advantages

The method according to the invention enables gentle metering of a viscous dough or paste mass enriched with gas under pressure with controlled, trouble-free formation of the microfoam structure in the metered dough or paste mass. The gluten-free, foamed bakery product may have contents of vegetable proteins admixed in the range from 5 to 70% (W/W), respectively based on the dry mass. The controlled foam structure setting for gluten-free and/or vegetable protein-enriched doughs/pastes/baked goods allows the product quality requirements to be achieved in terms of dough handling properties, product volume, crumb structure, texture and aroma in a way that is comparable to, and even better than, conventional baked goods.

The coupled mixing and metering method according to the invention provides a technology in which, by means of gas enrichment of the doughs or pastes under high pressure and pressure control throughout the entire production and metering process and by using the adjusted dough or paste viscosity, delayed foaming is only achieved immediately upon metering. Even at high dough or paste viscosity/viscoelasticity, this ensures the formation of a foam/sponge-like structure with low density or alternatively high baking volume as well as preferred texture consistency without needing to accept the partial to complete destruction of the foam structure of conventional metering processes.

The mixing and metering method according to the invention thereby enables partial to complete foam structure destruction by avoiding flow stress on a dough or paste foam already present in the manufacturing and metering process. This fulfills a key prerequisite for optimally homogeneous product foam structure formation with uniform, narrow gas bubble size distribution at a defined degree of foaming. This ensures an improvement of the foam stability as a result of reduced Ostwalt ripening effects (=progressive disproportionation of gas bubble structures as a result of different bubble-internal Laplace pressures due to different bubble sizes). Uniformity and stability of the foam structure are further supported by the fact that, pursuant to the method according to the invention, gas bubble nucleation is achieved by appropriate control of the local static pressure and by ensuring a high-number concentration and homogeneous distribution of particles nucleating gas bubbles, by heterogeneous nucleation at the end of the outlet from the metering nozzle and, thereby, the significant proportion of the gas bubble expansion as a result of pressure relief only takes place outside the metering nozzle, which is to say, in the baking mold or alternatively on the baking conveyor belt. This results in narrowly distributed gas bubbles in spherical form, since they do not experience any superimposed flow forces during their expansion process. Finally, it can be assumed that the uniformity of the dough or paste structure set according to the invention enables improved homogeneous baking with reduced baking time, in particular in the case of combined microwave convection baking as preferred according to the invention.

In addition, the controlled adjustment of the dissolved gas component in the dough or paste product with the concomitant uniform production of a microfoamed dough or paste and baked product structure, as described above, allows the entire production process for correspondingly produced baked goods to be significantly shortened due to the fact that yeast fermentation is not required, with a concomitant significant reduction in product defects and thereby significantly increased production efficiency.

### Further Inventive Configuration

Further inventive configurations are described below.

According to an embodiment, the dough, the paste or the powder is transported into one or a plurality of extruders, each extruder having at least one, preferably two, motor-driven extruder screw(s) equipped in different zones with conveying and/or mixing and/or dispersing elements, wherein the relevant extruder(s) are closed gas-tight at both ends during the conveying process, such that no gas loss occurs by the addition of gas into the process space of the interior of the respective extruder screw channel formed for gas dispersion and/or gas dissolution under pressure, and the gas within the relevant partial area of the extruder screw channel is finely dispersed and/or dissolved completely in the dough or in the paste under increased static pressure in a controlled manner and no foam formation is initiated until immediately before the outlet opening of the metering valve device.

The method according to an embodiment of the present disclosure is characterized in that a free-flowing, dry powder or a free-flowing powder mixture for the production of a dough or a paste is introduced into the extruder screw channel of at least one or a plurality of motor-driven extruder screw(s) and a preferably aqueous fluid system is added to this free-flowing powder mixture or the free-flowing powder at the beginning of the extruder screw channel for the production of a sufficiently high-viscosity dough or a high-viscosity paste which is used as a fluid- and gas-tight sealing plug in the front area of the extruder screw channel and at a distance therefrom, in the extruder screw channel, a further portion of a preferably aqueous fluid system is added to this to produce a significantly diluted, low-viscosity dough or a low-viscosity paste, and gas is subsequently added under pressure to this low-viscosity dough or this low-viscosity paste, and this gas is converted, under superimposed shear in the extruder screw channel, in particular in the gap between co-rotating conveyor screws, which conveyor screws are preferably produced thin flow layers, into a solution or alternatively a microdispersion state with gas bubbles in the diameter range ≤10 micrometers, preferably ≤4 micrometers, in the dough or paste system, as well as while avoiding foam formation, this solution/dispersion state is maintained until bubble nucleation is specifically initiated and increased in the gas-containing dough or in the gas-containing paste shortly before discharge from one or more discharge/metering devices by secondary, heterogeneous gas bubble nucleation and pressure reduction.

According to the methods described above, the framework conditions for the controlled setting of defined static pressure ratios in the gas dissolution zone VI of the process are determined. The configuration of a “dough plug” to seal off the process space in the opposite direction to the continuous transport direction, as well as the fluid metering required for this in accordance with the invention as a function of the static gas dissolution pressure to be set under predetermined temperature and dwell time conditions, play a decisive role.

According to an embodiment, the method in which the control of the fluid supply at the two or more fluid supply devices in the extruder screw channel is carried out as a function of the viscosity of the dough or the paste, wherein in a mixing zone sealing conditions, against fluid and gas backflows from the fluid supply zone-2 downstream in the flow direction from the mixing zone and in particular the compressed gas supply zone, are implemented by the formation of a dough or paste plug of higher dynamic viscosity which dynamically seals the extruder screw channel, whereby, as a result of this dynamic sealing, static pressures between 5 to 100 bar are provided in the gas dissolution measuring and extruder outlet zone configured as a gas dispersion and dissolution zone, and thereby optimum gas dissolution and/or micro-dispersion conditions are provided for the gas phase in the dough or in the paste with dwell times in this gas dissolution measuring and extruder outlet zone formed as a gas dispersion and dissolution zone between 10 to 120 seconds, preferably between 30 to 60 seconds, wherein the axial distance between the fluid supply devices is continuously adjusted and the fluid supply devices are locked in predetermined positions, optionally positions matched to the dough or paste recipe, and the gas-enriched dough or the paste is discharged in a container, a pouring or baking mold, a package or on a conveyor belt via one or more discharge/dosing elements configured as a metering valve device(s), wherein a static pressure control/pressure conduction brings about the adjustment of the degree of gas microdispersion and/or gas dissolution in the dough or in the paste, as well as for the dissolved gas portion, the gas bubble nucleation or the initiation of bubble expansion is relocated to the outlet end of the discharge/metering elements configured as metering valve device(s) and the further bubble expansion and foam formation are carried out at least ≥20%, preferably ≥50% in the already metered dough or in the paste, with which a fluidically undisturbed, spatially uniform gas bubble expansion with resulting narrow bubble size distribution is described by characteristic SPAN values (SPAN=(x_{90.3}-x_{10.3})/x_{50.3},) for the metered, foamed dough or the paste in the range of ≤1.5, preferably ≤1.2, most preferably ≤1, and foam bubble diameter or pore diameter x_{50.3} (A) from 4 to 200 micrometers, preferably from 20 to 100 micrometers, for the freshly extruded foamed dough or paste, and (B) from 10 to 250, preferably from 20 to 150 micrometers, for the product produced from foamed dough or paste by post-treatment with optimized baking processes, and wherein one or more of the following system parameters are used as control variables for the quantitative adjustment of the mean bubble/porous diameters (x50.3) as well as their size distribution width (SPAM):
(a) dough or paste viscosity,
(b) number density of bubble nucleation nucleator particles added to the dough system,
(c) dough or paste mass flow,
(d) total mass-related gas component added,
(e) rotational speed of the extruder screw,
(f) Opening cross-sectional areas of the metering valves, which, as a function of (a) to (e), define the spatial and temporal pressure relief gradients, wherein the pressure relief gradients directly correlate with the corresponding spatial and temporal gas bubble nucleation and expansion gradients.

According to an embodiment, the supply of fluid, preferably aqueous-based, and gas is adjusted in a controlled or regulated manner as a function of the dough or paste recipe, wherein (A) the first fluid metering takes place by means of the fluid supply device-1 at an axial extruder screw length L1, measured in conveying direction, which corresponds to 2 to 8 times the extruder screw diameter D (L/D=2 to 8), and in that the second fluid metering is applied by means of the fluid supply device-2 at an axial extruder screw length L2, measured in conveying direction, which corresponds to at least 10 to 14 times the extruder screw diameter D (L/D=10 to 14), and wherein (B) the metering of the foaming gas takes place by means of the compressed gas supply device in the form of CO₂ or N₂ or N₂O₂ or air or mixtures thereof under a static pressure of 5 to 100 bar, preferably under a pressure of 15 to 35 bar, with a gas volume fraction of between 5 and 70% (V/V), based on the pressure-relieved ambient state of the dough or alternatively the paste, in the extruder at an axial extruder screw length L3, which corresponds to at least 12 to 16 times the extruder screw diameter D (L/D=12 to 16), whereas for the length range of the gas dispersion and dissolution zone at least 12 L/D<20, preferably 14 L/D<26, when using an extruder with a total length of 28 D applies, whereas this and all previously specified L/D length scales with the factor (L/D)ₘₐₓ/28 are multiplied when using an extruder with (L/D)ₘₐₓ that is other than 28.

According to an embodiment, the method is carried out at a temperature below 160° C., preferably below 100° C. and further preferably below 60° C., and the foamed dough or paste after discharge into a container, a pouring or baking mold, a packaging means or on a conveyor belt is either baked by means of a convection baking process or preferably by means of a combined microwave-convection baking process or is cooled or frozen in a freshly extruded or partially baked state.

### Solution of the Task Relating to the Control and/or Regulating Device

According to an embodiment, a control and/or regulating device is provided with one or more motor-driven extruder screw(s), which are supplied by a powder or bulk material metering device configured, for example, as a hopper with a discharge element, wherein in a fluid supply zone-1 a free-flowing dough or paste or powder mixture is supplied by means of fluid supply device-1 with a recipe-specific quantity of a liquid, preferably on an aqueous basis, in order to achieve, in a downstream mixing zone, a dough or a paste of a specific, higher viscosity h₁, and wherein this dough or this paste is metered, in a recipe-specific manner, in a fluid supply zone-2 by means of fluid supply device-2 with an additional amount of fluid, in order to adjust the dough or the paste at a specific reduced viscosity h₂<h₁, and wherein, furthermore, gas is subsequently metered, in a controlled manner, in a compressed gas supply zone by means of a compressed gas supply device that is upstream at an axial distance from the fluid supply device-2 under pressure, in order to achieve a certain foam density in the final product, wherein the introduced gas is subsequently dissolved or homogeneously microdispersed under a controlled, increased static pressure, whereas a sensor measuring the electrical conductivity determines the degree of dissolution or alternatively microdispersion of this gas in the aqueous dough or paste phase, in order to indicate the degree to which an equilibrium value of the gas dissolution/microdispersion is achieved during a predetermined dough or paste dwell time at the end of the gas dispersion and dissolution zone VI in the region of the device designated as gas dissolution measuring and extruder outlet zone VII, wherein based upon this measurement, the controlled adjustment of the proportion of dispersed or alternatively dissolved gas is achieved by means of a feedback loop control using actuators, which are either (a) a back pressure valve device configured as a bypass back pressure valve in a preparation phase of the metering process or (b) at least one metering valve device in the activated metering phase of the process, and wherein the degree of opening of these valves determines the static pressure in the gas dispersion and dissolution zone VI, and thereby controls the dispersion and/or dissolution kinetics and the proportions of the dissolved or microdispersed gas or alternatively gas mixture in the dough or in the paste, which is confirmed by achieving an appropriately measured in-line conductivity value k.

A further embodiment is characterized in that the controlled adjustment of the dough or paste shear viscosity:
A: takes place in the fluid supply zone-1 to a value of 10≤h₁<1000 Pas, preferably 50≤h₁<200 Pas, which ensures sealing upstream by the dough or paste in the extruder screw channel against gas or fluid backflow from fluid supply zone-2 IV or the compressed gas supply zone V, wherein the viscosity h₁ takes into account the non-Newtonian flow behavior of the dough by referring to an average shear rate of 100 s⁻¹, which preferably acts in the mixing zone III and wherein the related viscosity function h(g.) is determined offline by dough or paste rheometry, preferably by means of high pressure capillary rheometer or rotational rheometry, —as well as:
B: takes place in the fluid supply zone-2 to a value of 1 Pas≤h₂<20 Pas, preferably 5 Pas≤h₂<10 Pas, and in the thereby viscosity-reduced fluid dough or paste phase, after compressed gas supply in the compressed gas supply zone in the gas dispersion and dissolution zone VI arranged downstream of the latter, sufficient gas is microdispersed and/or dissolved in the compressed gas supply zone within a characteristic dwell time of 30 to 300 s, preferably 50 to 120 s, in order to achieve a degree of foaming in the end product, expressed as the gas volume fraction f_{G,v} of the total product volume, in the range 10≤f_{G,v}<75% (V/V), preferably 20≤f_{G,v}<50% (V/V), and connected therewith a correspondingly reduced density in the final product, wherein the viscosity h₂ takes into account the non-Newtonian flow behavior of the dough or of the paste by preferably relating to an average shear rate of 200 s⁻¹ which preferably acts in the gas dispersion and dissolution zone VI, wherein the relevant related viscosity function h(g.) offline is determined by means of high pressure capillary rheometry or rotational rheometry.

A control and/or regulating device provided is characterized in that the adjustment of the static pressure in the gas dispersion and dissolution zone VI is carried out as a function of the electrical conductivity value k measured in the subsequent gas dissolution measuring and extruder outlet zone VII, wherein the degree of attainment of a pressure-dependent equilibrium value for the electrical conductivity k_{equ} (p_{stat.}) is a measure of the degree of gas-dough mass transfer achieved during the dough or paste dwell time in the extruder screw channel within the gas dispersion and dissolution zone VI, and thereby the concentration of the finely dispersed and/or dissolved gas in the dough or in the paste c_{GAS} is adjusted in a recipe-specific manner in accordance with the conductivity value k measured in-line, wherein the relevant combination of dwell time t_{V(30)} or dough or alternatively paste volume flow (dV/dt)_{Product} and static pressure pₛₜₐₜ₍₃₀₎ in the gas dispersion and dissolution zone VI is adjusted on the basis of a calibration function k=f(pₛₜₐₜ₍₃₀₎, tv), which is determined in a preliminary test by means of extruder/back pressure valve device coupling, and wherein the static pressure Pₛₜₐₜ₍₃₀₎ at the end of gas dispersion and dissolution zone VI, as well as the electrical conductivity k in of the subsequent gas dissolution measuring and extruder outlet zone VII are determined in this preliminary test, while varying the free cross-sectional flow area A_{GDV} in the back pressure valve device for a selected rotational speed n_{S} of the extruder screw and dough or paste mass flow (dm/dt)_{Product}, from which transferable optimum combinations of the above process variables with continuous metering are derived according to the degree of foaming to be achieved in the metered dough and stored in a database for regular process control.

According to an embodiment, a control and/or regulating device is characterized in that, for a given dough or paste mass flow (dm/dt)_{Product} and recipe-related dough or paste viscosity, a feedback loop control is applied with a given electrical conductivity kₛₑₜₚₒᵢₙₜ as reference variable w, wherein the static pressure pₛₜₐₜ₍₃₀₎ in the gas dispersion and dissolution zone VI is integrated as indirect manipulated variable y, and the electrical conductivity k measured in the gas dissolution measuring and extruder outlet zone VII is integrated as a controlled variable, and wherein either a back pressure valve device in a bypass line, or at least one metering valve device, and/or a compressed gas supply device and/or a rotational speed-adjustment apparatus for the rotational speed n_{S} of the extruder screw coupled to the extruder screw drive motor, are used to adjust the static pressure in the gas dispersion and dissolution zone in a defined manner, wherein a back pressure valve device is used in a bypass line in a preparation run (A) to the regular metering process to determine the static pressure pₛₜₐₜ₍₃₀₎ in the gas dispersion and dissolution zone VI, which is achieved under the specific process conditions set with regard to dough or paste mass flow (dm/dt)_{Product}, gas mass flow (dm/dt)_{Gas} and rotational speed n_{S} of the screw under specification of product recipe and screw geometries, and which degree of gas dissolution or microdispersion (dm/dt)_{Gas(L,D)}/(dm/dt)_{Gas} is determined, measured via the electrical conductivity k [(dm/dt)_{Gas(L,D)}/(dm/dt)_{Gas}], which adjusts in the dwell times t_{V(30)} realized in the gas dispersion and dissolution zone VI, wherein (dm/dt)_{Gas} designates the total mass flow of gas added and (dm/dt)_{Gas(L,D)} designates the mass flow of the dissolved (dm/dt)_{Gas(L)} and the micro-dispersed non-dissolved gas component (dm/dt)_{Gas(D)}, wherein the latter two variables additionally depend on the type of gas used, and wherein, when switching over from this preparatory run (A) carried out in bypass mode with back pressure valve device to the regular metering process (B), in which one or more connected metering valve devices are activated, these ensure, by adjusting the degree(s) of opening of the metering valve(s), that the static pressure and the thereby set degree of gas dissolution or gas dispersion in the gas dispersion and dissolution zone VI, measured via the electrical conductivity of the dough or of the paste, are at the same level as in the preparation test run using the back pressure valve device in the bypass line, and that, for the regular course of the metering process (B), 2n metering valve devices with n=1 to 20, n denoting half the number of metering valve devices used, are alternately metering in two groups with n metering valve devices each, and thereby that the level of static pressure in the gas dispersion and dissolution zone VI remains constant when switching between the two metering valve device half-groups, which are configured in a similar manner with respect to flow pressure losses, apart from negligible short-term (<0.5 s) pressure fluctuations during the switching process.

### Some Advantages

In principle, the technical framework conditions according to the invention for the interplay between the static pressure to be set, the gas quantity to be dissolved, the gas type and the assigned geometric conditions of the reaction space in the exemplary embodiment of a twin-screw extruder system are described in more detail in the above-mentioned control and/or regulation claims. The dissolution kinetics of the gas to be dissolved is determined by the static pressure, the temperature and the specific gas dissolution behavior (depending on the type of gas) in the specified dough recipe. Since, depending on the dough recipe, different water contents and substances dissolved in the water phase are present, the gas solubility kinetics required for the design of the method are determined in a laboratory measuring apparatus by setting the relevant basic conditions. In so doing, according to the invention, flow conditions of the dough or paste mass are also adjusted in this apparatus, which simulate typical shear stresses as they occur in the extruder screw geometries used. In this way, gas solubility kinetics determined in accordance with the invention are used to design flow conditions and dwell times in the process space in which the gas is dissolved.

At the end of the gas dispersion and dissolution zone according to the invention, the proportions of dissolved or undissolved gas components are detected by an installed conductivity sensor. When, for example, carbon dioxide (CO₂) is used as the foaming gas, the dissociation of the CO₂ in the dough/paste/water phase is determined according to the invention as the decisive parameter influencing the conductivity of the dough or paste system or alternatively the change in conductivity. For other gases to be used for foaming (for example, N₂, N₂O₂), which do not cause dissociation in aqueous solutions and the thereto connected electrochemical changes in the system, the undissolved, finely dispersed gas component, which leads to a reduction in conductivity, is used according to the invention as a measure of the degree of gas enrichment/fine gas dispersion in the dough or paste system. According to the invention, a back pressure valve is installed in an extruder outlet bypass line, in combination with the conductivity sensor, to complete the basic control circuit. According to the invention, the free cross-sectional area of the back pressure valve is adjusted as a function of the dough or paste supply rate (mass flow dm_{Dough}/dt) and the metered added quantity of gas in such a way that at a selected position in the extruder screw channel (typically at the end of the gas dispersion and dissolution zone (30); in FIG. 3 at L/D=42) a static pressure is reached, at which static pressure the conductivity assumes an equilibrium value (see FIG. 3: for example, conductivity value of 4.35 S/m for 0.7% (W/W) CO₂ at 30 bar), which corresponds to a defined mass of dissolved gas and an assigned gas volume fraction f_{G} in the product (here, for example: 0.7% (W/W) CO₂=>f_{G}=0.75). Below this related gas weight component of gas (here: CO₂), which corresponds to a gas volume component of approximately f_{G}=75% (=Overrun of approximately 300%) under ambient pressure, the adjustment of a specific gas component (or degree of foaming=overrun) in the resulting foamed product can thus be realized by the control according to the invention. The adjustment of the static pressure by means of a dynamic pressure valve in the extrusion test is additionally dependent on the dough or paste mass flow and the dough or paste viscosity, inasmuch as these have a decisive influence on the flow forces acting in the dynamic pressure valve. These interrelationships are determined in calibration test runs specific to the dough recipe and used as a basis for the corresponding control algorithm.

When the regulation is activated, the static pressure in the gas dispersion and dissolution zone is adjusted in a controlled manner via the back pressure valve and the conductivity sensor is activated in order to detect the degree of dissolution of the added gas that is as complete as possible under the given pressure, temperature and dwell times conditions. In a variation of the “normal control case” described here, the gas solubility sensor can also detect a defined partial solubility of the gas and allow the static pressure to be adjusted accordingly.

The decisive advantage of a complete dissolution of the added gas component consists in that improved determined framework conditions for the adjustment of the metering valve device are given for the prevention of foam formation in the metering lines or alternatively in the metering valve, which represents the optimum prerequisite for homogeneous dough or paste foam generation after discharge from the metering nozzle without local mechanical structural damage. Due to natural product ingredients which are used in dough or paste recipes, changing/fluctuating gas solubility conditions are to be expected in the process flow according to the invention. These can be compensated by the control according to the invention using the conductivity sensor and the back pressure control valve, thereby allowing comparable foam structures to be achieved even under fluctuating raw material conditions.

### Solution of the Task Relating to the Device

According to an embodiment, a method is provided for the combined, continuous mixing and metering of doughs or pastes enriched with gas under static pressure, for the manufacture of foamed products, in particular, baked goods, preferably gluten-free baked goods, using one or a plurality of motor-driven extruder screws, each with a feed hopper for free-flowing dry powder or for free-flowing dry bulk material mixtures, at least two fluid supply devices arranged in the longitudinal axial direction of the extruder concerned, by means of which different fluid quantities are supplied to the extruder screw channel in a controlled or regulated manner via valves, a compressed gas supply device via which gas is introduced into the extruder screw channel under pressure of 5 to 100 bar and in measuring or sensor devices assigned to the extruder screw channel in process-specific zones I to VII in the conveying direction (X), which measure the static pressure or alternatively the static pressure development along the extrusion process space and measure the dissolved or microdispersed gas content in the dough or in a paste after the gas dispersion and dissolution zone VI, as well as a dough or paste discharge back pressure valve element arranged in a bypass line and configured as a back pressure valve device, the outlet cross section of which can be continuously varied to build up a static back pressure in the extruder screw channel by using a flexible high pressure hose the cross section of which can be adjusted by means of two adjusting pistons, as well as at least one metering valve device configured as a dough or paste discharge metering valve element, which has one or more metering nozzles, the latter optionally arranged in groups with nozzle end discharge cross sections that can be exchanged or adjusted to metering pressure, fluid viscosity and metering mass flow.

### Some Advantages

Important parts of the device according to the invention are (a) the continuous mixing and conveying device, which according to the invention is preferably configured as a co-rotating twin-screw extruder, (b) the supply and metering devices with connection points for the liquid components (preferably water/aqueous solutions) and the foaming gas (typically CO₂, N₂, N₂O₂) at specified positions at determined positions of the mixing-/conveying device, (c) the bypass product line with integrated back pressure valve device for static pressure adjustment, as well as (d) the metering valve device with integrated metering valve(s). According to the invention, the latter have optimized channel/gap geometries in order to keep the expansion section of the dough system to be metered with gas component dissolved under pressure extremely short.

The selection, arrangement and design of the device elements according to the invention described above require: (i) the adjustment of a defined static pressure in the gas dispersion and dissolution zone, (ii) the measurability of the dissolved gas component in the dough in the gas dispersion measuring and extruder outlet zone, (iii) the adjustability of the static pressure via the degree of opening of the bypass-back pressure valve device with the metering valve closed, which is to say, before activation of the metering process, as well as (iv) after activation of the metering process, the defined metering of a dough or paste quantity with dissolved gas component before its significant expansion by foaming via the metering valve.

### Further Inventive Embodiments

Further embodiments according to the invention are described below, which describe an optimum embodiment of a device operating under production conditions, with which the method according to the invention can be used to manufacture large quantities (t/h) of products from foamed dough systems.

An advantageous device according to the invention is characterized by at least one metering valve device (38) configured as a discharge metering valve element, which can be closed by an adjusting piston (48), which, in the open state of this metering valve device, frees the outlet nozzle cross-section and comprises a large cross-sectional flow area A1 all the way to the valve outlet chamber (61) as well as subsequently over a short length of 1 mm to 40 mm, preferably 5 to 15 mm, in the valve outlet channel (67), which has a distinctly narrowed flow channel cross-section with cross-sectional area A2, wherein preferably A2≤0.01 to 0.5 A1 and further preferably A2≤0.05 to 0.3 A1 applies, and in the metering case (a), on the one hand, a sufficiently high back pressure of ≥2 bar, preferably ≥5 bar and further preferably ≥10 bar is built up upstream of the metering valve device (38), which back pressure has an impact all the way into the gas dispersion and dissolution zone (30), and there achieves a set level of gas dissolution and/or gas microdispersion, as well as (b) on the other hand, a static pressure reduction only occurs in the metering nozzle outlet channel (65), which reduction leads to gas bubble nucleation and incipient gas bubble expansion, and wherein the outlet cross-section, which can be closed in a sealing manner by means of adjusting pistons (48), preferably comprises a conically narrowing annular cross-section of the flow channel, wherein the stroke of this adjusting piston is adjustable in a manually or motor-controlled manner and, thereby, with an increased stroke, an annular flow cross-section tapering conically in the cross-sectional area can be released for the dough or paste mass to be metered, wherein the mean cross-sectional flow area of this conical annular channel is variable, preferably continuously adjustable, by a factor of ≤2, preferably by a factor of ≤10, over the entire range of the adjustable stroke length of the valve plunger.

According to an embodiment, a device which is characterized in that an extruder screw channel, preferably of a co-rotating twin screw extruder, with a length of L/D=14 to 50 (where L=screw channel length and D=screw diameter) is provided for the controlled pressure build-up and the gas dissolution in the dough or in the paste, and the extruder length is subdivided into seven length segment zones of respective segment length between L/D=2 and L/D=10, equipped with screw elements of different geometry with regard to flow-mechanically optimized function, and the following specific functions are assigned to these seven length segment zones:
Zone I: powder receiving and compression zone; metering and compression of the powder mixture;
Zone II: fluid supply zone-1; first fluid supply.
Zone III: mixing zone; mixing/kneading and formation of a high-viscosity dough or paste plug sealing the extruder screw channel against zones IV and V
Zone IV: fluid supply zone-2; fluid mixing and reduction of the dough or paste viscosity
Zone V: compressed gas supply zone; introduction of gas component under static pressure up to 100 bar.
Zone VI: gas dispersion and dissolution zone; microdispersion and/or dissolution of the admixed gas component.
Zone VII: gas dissolution measuring and extruder outlet zone; approach to gas dispersion and/or gas dissolution equilibrium condition, measurement of static pressure and electrical conductivity as well as inlet into bypass or metering nozzle supply lines.

and in accordance with the functional assignments of zones I-VII, the extruder screw is equipped with elements which optimally support the assigned functions (i) in terms of flow, (ii) in terms of dwell time and (iii) in terms of power input, wherein, as a function of recipe composition and dough- or paste-system-specific gas dissolution or alternatively dispersion kinetics, a change of the extruder zone lengths (24 to 31) for the aforementioned assigned functions by approximately ±1 to 2 L/D segment lengths takes place in such a way that the closest possible approximation of a micro-gas dispersion or gas dissolution equilibrium state is achieved in zone VI.

### Solution of the Task Relating to the Product

According to an embodiment, a product is provided which is gluten-free, comprising a non-gluten-containing proportion of plant proteins of between 5 and 70% (W/W), preferably between 5 and 40% (W/W), based on dry substance, and a gas volume fraction in the untreated dough or paste of 0.1 to 0.75, preferably 0.25 to 0.5, and in the post-treated or baked product of 0.2 to 0.9, preferably 0.3 to 0.7, wherein (A) the doughs or alternatively pastes foamed in this way comprise mean foam bubble or alternatively pore diameters x_{50.3} of 4 to 200 micrometers, preferably of 20 to 100 micrometers, as well as characteristic SPAN values ((x_{90.3}-x_{10.3})/x_{50.3} with x_{10.3}, x_{50.3}, x_{90.3} as 10%-, 50%-90% percentiles of bubble/porous diameter volume distribution) for characterization of the bubble or alternatively porous diameter distribution width of ≤2, preferably ≤1.5, most preferably of ≤1, as well as (B) for the foam structures obtained from such dough or paste systems by post-treatment with optimized baking processes, preferably comprise mean bubble or alternatively pore diameters of x_{50.3}=10 to 250, preferably of 20 to 150 micrometers and resulting SPAN values ≤2.5, preferably ≤1.5, most preferably of ≤1.

### Some Advantages

The described products according to the invention enable a sensory preferred loose product structure, which can also be realized for high-viscosity dough systems, the foaming behavior of which has only been able to be configured in an insufficient manner up to now. This is, in particular, the case when, for example, gluten-free baking mixtures are used which can only be formulated in a suboptimum manner in the absence of network-forming components that support foam formation and foam stability. Thereby, products according to the invention can advantageously be realized for an extended range of dough systems with sensorially and nutritionally optimized recipes in a foam structure quality not previously known to the consumer and connected optimized sensorial properties (processing behavior, appearance, consistency, development of flavor/aroma).

### Further Inventive Embodiments

A further embodiment according to the invention is described, wherein the product contains (A) a gluten-free vegetable protein content from 5 to 70% (W/W), preferably from 10 to 50% (W/W), in relation to dry mass, (B) a carbohydrate content from 5 to 70% (W/W), preferably from 10 to 50% (W/W), in relation to dry mass, (C) a dietary fiber/plant fiber content of from 3 to 30% (W/W), preferably from 5 to 15% (W/W), in relation to dry mass, (D) a fat/oil content of from 0 to 30% (W/W), preferably from 5 to 10% (W/W), in relation to dry mass, and (D) contains a native starch content, preferably potato, corn or rice starch of ≥1 to 5% (W/W), in relation to dry mass, wherein the last-mentioned content preferably consists of native potato, corn or rice starch or mixtures thereof at the same total percentile content pretreated by means of freezing-thawing cycles to equal total percentages and acting as a nucleator particle component supporting gas bubble nucleation.

### Solution of the Task Relating to Use

According to an embodiment, a product produced by the method includes the use of a foamed, dough- or paste-based product as a base for long-life baked goods, preferably (A) ready-to-eat gluten-free long-life or fresh baked goods, (B) as a base for fresh or pre-baked and subsequently frozen baked goods, (C) in baked form or alternatively, as a result of protein denaturation, in other thermally stabilized form, as a chunky inclusion component in a chocolate confectionery, ice cream or in another dessert product or in a vegetable or meat pie product, and/or (D) as a coating, covering or surface decoration component of products in chocolate confectionery, ice cream, other desserts, cheese/fresh cheese, meat products, meat-based/meatless (vegetarian or vegan) pies.

### Some Advantages

Some dough or paste products manufactured to date have been limited in their formulations by the need to take into account aspects relating to compatibility and health, in order to produce optimum foam-like loose structures, which are preferred from a sensory point of view. In long-life baked goods, the last-named structures offer the significant advantage of reduced hardness as well as the possibility of improved penetration with other product components such as fillings or fluids, which opens up new areas of development in terms of sensory and nutritional optimization.

The use of products which are manufactured according to the invention as product subcomponents relates in particular to composite products in the food sector. In product categories such as chocolate confectionery, where baked waffles/wafers or cookie structures are often to be embedded, the stable bonding of such inclusion components, for example, in bars, is an important quality feature. Comparable considerations apply to such bakery-based inclusion components in ice cream or in pies produced according to the invention. For the latter, wrappers with foam-based dough components produced according to the invention are also of importance.

### BRIEF DESCRIPTION OF THE DRAWINGS

The invention is illustrated—in part in a schematic manner—by way of example, in the diagrams and sketches. Wherein:

FIG. 1 shows an apparatus according to the invention with a motor-driven screw conveyor configured as a continuous conveyor/extruder, partly in schematic exploded view;

FIG. 2 shows a valve device from FIG. 1 configured as a back pressure valve, in longitudinal cross-section, on a larger scale;

FIG. 3 shows a metering valve device from FIG. 1, shown partly in cross-section, partly broken off in a top view, on a larger scale;

FIG. 4 shows a detail from FIG. 3 shown on a larger scale, partly in cross-section, partly broken off;

FIG. 5 shows an illustration corresponding to FIG. 3 with a different stroke position of the metering valve piston, likewise shown partly in cross-section, partly in top view, partly broken off;

FIG. 6 shows a detail from FIG. 5, shown on a larger scale, partly in cross-section, partly broken off;

FIG. 7 shows a circuit diagram for the control/regulation of the apparatus shown in FIG. 1;

FIG. 8 shows a diagram representation of the exemplary measured relationship between the electrical conductivity measured in-line of a dough under defined static pressure (here 30 bar) as a function of the metered gas quantity (here CO₂) in the gas dispersion and dissolution zone (30) under equilibrium conditions;

FIG. 9 shows a schematic representation, in the form of a block diagram, of the “feedback control circuit” for the defined adjustment of the degree of foaming gas dissolution under the static pressure effective in the gas dispersion and dissolution zone, based on the electrical conductivity k measured in-line in this zone;

FIG. 10 shows a schematic diagram representation of the temporal relationships between the physical process variables when adjusting the static pressure pₛₜₐₜ in the gas dispersion and dissolution zone during the metering preparation phase using the back pressure valve device acting as an actuator in this phase;

FIG. 11 shows a schematic diagram representation of the temporal relationships between the physical process variables when switching between the back pressure valve device (metering preparation phase) and the metering valve device (metering phase);

FIG. 12 shows an external shape/structure of a dough product produced according to the invention (here model cake with 30% (W/W) protein content (recipe M1));

FIG. 13 shows an external shape/structure of a dough product produced according to the invention (here model cake with 24% (W/W) protein content (recipe M2);

FIG. 14 shows an internal foam structure of a dough product produced according to the invention (here model cake with 30% (W/W) protein content (recipe M1)) with metering of 0.2% (W/W) CO₂ as foaming gas;

FIG. 15 shows an internal foam structure of a dough product produced according to the invention (here model cake with 24% (W/W) protein content (recipe M2)) with metering of 0.2% (W/W) CO₂ as foaming gas;

FIG. 16 shows an internal foam structure of a dough product produced according to the invention (here model cake with 30% (W/W) protein content (recipe M1)) with metering of 0.3% (W/W) CO₂ as foaming gas;

FIG. 17 shows an internal foam structure of a dough product produced according to the invention (here model cake with 24% (W/W) protein content (recipe M2)) with metering of 0.3% (W/W) CO₂ as foaming gas;

FIG. 18 shows an internal foam structure of a dough product (here model bread with 10% (W/W) protein content, recipe M3) WITHOUT metering of foaming gas;

FIG. 19 shows an internal foam structure of a dough product (here model bread with 10% (W/W) protein content, (recipe M3)) with metering of 0.5% (W/W) CO₂ as foaming gas;

FIG. 20 (identical to FIG. 19, repeated for improved direct structure comparison) shows an internal foam structure of a dough product (here model bread with 10% (W/W) protein content, (recipe M3)) with metering of 0.5% (W/W) CO₂ as foaming gas;

FIG. 21 shows an internal foam structure of a dough product (here model bread with 10% (W/W) protein content, (recipe M3)) with metering of 0.8% (W/W) CO₂ as foaming gas, and

FIG. 22 shows the experimentally determined functional relationship between the gas component introduced into a dough/paste system (here gluten-free bread dough) under elevated static pressure and the resulting degree of product foaming.

### DETAILED DESCRIPTION

In the drawing, the invention is shown in use on an apparatus designated overall by the reference sign 1, which comprises at least one continuous conveyor configured as a screw conveyor 2, preferably two co-rotating intermeshing screw conveyors, which are driven by a motor 3 or a plurality of motors, for example, respectively, a controllable servomotor or asynchronous motor, possibly by means of a gearbox or by means of a geared motor. Preferably, several screw conveyors 2 which can be equipped with different screw geometries will be selected, since from a process- and material consistency-specific point of view, these allow not only a steady transport, but also a good mixing and/or mechanical pressure/shear stress of the material to be transported to be ensured.

The screw conveyor 2 is arranged in a housing 4 and conveys a dough- or paste-forming powder mixture in the direction X. The bulk or pourable powder mixture (for example, dough mixture, not shown) is supplied to a hopper 5 from a source not shown, for example, from a silo. The hopper 5 may be provided with a suitable gravimetric or volumetric control or regulation apparatus to determine the respectively desired powder mass flow.

The dry bulk or pourable powder mixture or the like is added to the hopper 6 and initially transported in the dry, pourable state by a predetermined amount in the direction X by the conveying screw 2 and thereby compacted in the screw channel (preferably twin screw channel), before a fluid, for example, water and/or a multiphase fluid system, for example, an emulsion, is added to the powder mixture or the like in a controlled or regulated manner via a fluid supply device-1 7 and a line 8, which is conductively connected to a fluid supply device-1 9. The fluid supply device-1 9 is fluidically connected via a line 10 to a fluid supply source, for example, to a water line or, for example, to a tank containing an emulsion. The fluid supply device-1 9 may be a motor-driven, controllable or adjustable pump driven by an electric motor (not shown).

The amount of fluid supplied via the fluid supply device-1 7 wets or moistens the dry powder mixture or the like and is mixed to it to form a relatively high-viscosity, rubbery dough/paste mass by means of the rotating conveying/extrusion screw(s) 2. This high-viscosity dough or paste mass forms a kind of sealing plug which is constantly degrading in conveying direction X but constantly renewing itself in the direction opposite to the conveying direction X, and which continuously seals the interior 11 of housing 4, which housing substantially corresponds to a screw channel or alternatively to a twin-screw channel, in a gas-tight manner towards hopper 6 and thereby towards the outside.

A second fluid supply device-2 12 is arranged at an axial distance from the fluid supply device-1 7 and is supplied by a second fluid supply device-2 14 with a predetermined amount of fluid via a line 13.

The second fluid supply device-2 14 receives a supply of the fluid, just as the first fluid supply device 7, for example, water or another suitable liquid or a fluid multiphase system, for example, an emulsion, by means of a line 13. Like the first fluid supply device 1 9, the fluid supply device 2 14 can be a controllable or adjustable pump which, like 9, is driven by a controllable or adjustable electric motor.

A compressed gas supply device 15 is arranged at an axial distance from the second fluid supply device-2 12, through which compressed gas supply device a gas, under positive pressure, is introduced into the process space 11 of the housing 4.

The reference sign 16 denotes a check valve, whereas 17 denotes a compressed gas line to which compressed gas, for example compressed air or another gas, can be supplied via a controllable or adjustable valve device 17a.

18 indicates a compressed gas source, which is only indicated schematically.

A measuring device 19, which is configured, for example, as a conductivity sensor, is arranged in the end area of the housing 4 of the apparatus 1 in order to measure the extent to which the compressed gas introduced into the interior 11 of the housing 4 via the compressed gas line 17 is dissolved in the dough or paste that is conveyed by the screw conveyor 2 in the direction X.

A pressure sensor is arranged at 20, which measures the pressure in the interior 11 of the housing 4.

The reference sign 21 designates an outlet nozzle and 22 an end plate, to which the outlet nozzle 21 is connected in a paste/dough-conducting manner.

A bypass line 23 is connected to the outlet nozzle 21 in a dough/paste-conducting manner, to which a back pressure valve device 24 is assigned, which is configured to be controllable or adjustable.

The apparatus 1 has several process-defined zones in the conveying direction X.

The reference sign 25 designates a powder material receiving zone in the form of a compression zone, whereas 26 designates a fluid supply zone-1.

Reference sign 27 designates a mixing zone and 28 designates a further fluid supply zone-2.

A zone 29 is formed as a compressed gas supply zone, whereas 30 represents a gas dispersion and dissolution zone.

The reference sign 31 designates a gas dispersion measuring and extruder outlet zone.

The reference signs 32 through 36 designate measuring devices in the form of static pressure sensors which measure and continuously display the pressure buildup in the various flow zones along the length of the apparatus 1.

A line 37 in the form of a metering line, to which a metering valve device 38 is assigned, is also connected to the outlet nozzle 21.

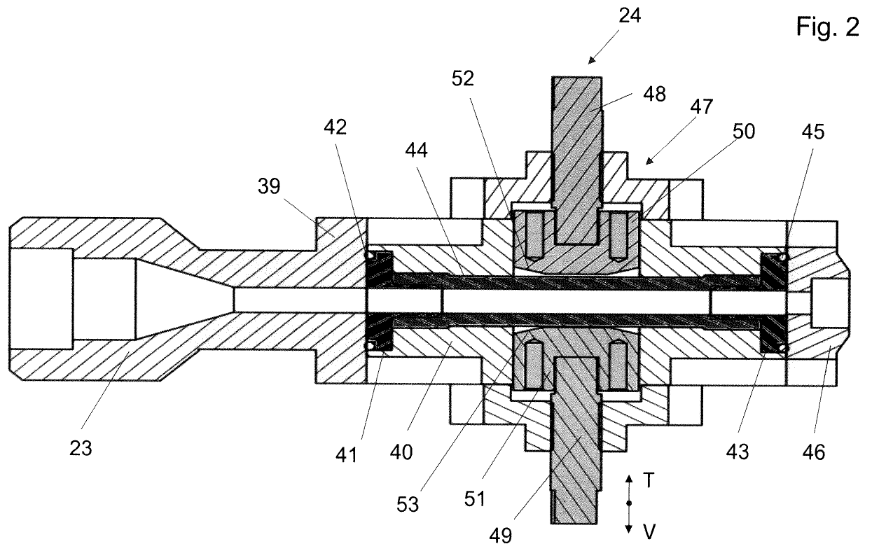

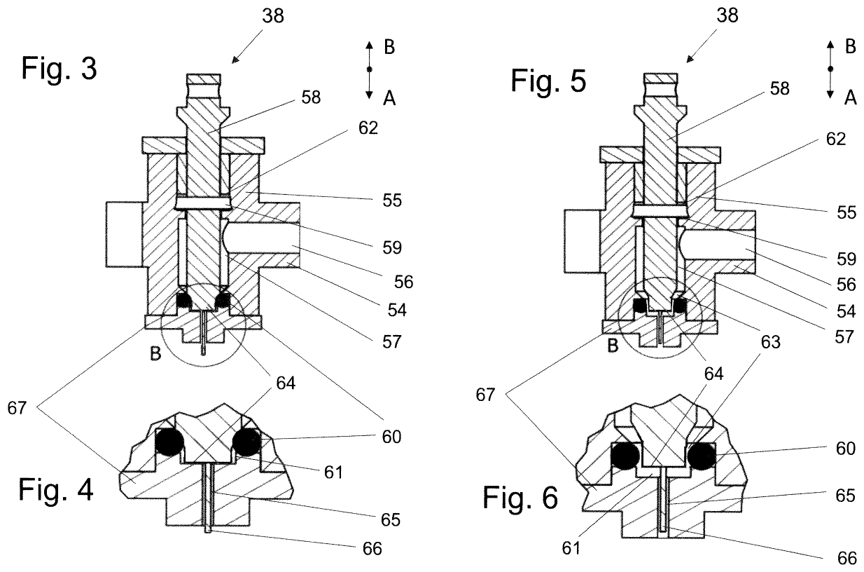

The back pressure valve device 24 is shown in detail in FIG. 2. The bypass line 23 is configured as a connecting nipple, which is arranged on the outlet nozzle 21, and is, for example, coupled in a sealing, detachable manner to the outlet nozzle 21 by means of a screw connection or the like (not shown).

The bypass line 23 is equipped with a flange 39 and is detachably connected in a sealed manner by means of screws or the like to a pinch valve device 40. As a central component, the latter contains a flexible high pressure hose 44 which is connected on both sides to high pressure hose connectors 41, 43 and sealed by means of high pressure O-ring seals 42, 45.

As can be seen from FIG. 2, the bypass line 23, the high pressure hose connectors 41, 43 and the high pressure hose 44 form a flow channel of constant cross-section, to which a cross-sectional adjustment device 47 is arranged orthogonally. This cross-sectional adjustment device 47 comprises diametrically opposed adjusting pistons 48 and 49, which are arranged respectively to be continuously but synchronously adjustable in opposite directions, which is to say in the directions T and V. The adjusting piston 48 and adjusting piston 49 is respectively assigned an adjusting head 50 or alternatively 51. In the embodiment shown, the adjusting heads 50 and 51 are form-fittingly but detachably connected to the assigned adjusting pistons 48 and 49, for example, by means of screw threads, and are thereby functionally one piece.

As can be seen from FIG. 2, the adjusting heads 50, 51 are domed on their top surfaces 52 and 53 that are facing each other and act on the outer circumferential surface of the flexible high pressure hose 44 against each other, but in a synchronous deforming manner. For this purpose, the adjusting pistons 48 and 49 are respectively adjusted in the direction T or alternatively V by a common drive or also by separate drives, for example, by impinging piston-cylinder units acting alternatingly on both sides in order to accordingly change the flow cross-section through the high-pressure hose 44. The adjusting pistons 48 and 49 can also themselves be part of a piston-cylinder unit, wherein the end sections of which each engage and form a seal in an axially adjustable manner in an assigned cylinder space, wherein a pressure medium, for example, a hydraulic fluid or compressed air, can be supplied under pressure on opposite sides in a controlled manner in order to synchronously and at a constant speed drive the adjusting pistons 48 and 49 in the direction T or alternatively V, either directed away from each other or against each other, in order thereby to either reduce or increase the flow cross section of the high pressure hose 44.

The domed design of the top surface 52 or alternatively 53 of the adjusting heads 50 and 51 prevents damage to the surface of the high pressure hose 44 and largely eliminates critical multi-axial stress conditions.

The metering valve device 38 comprises a connecting piece 54 which is part of a housing 55. The dough or paste mass enriched with dissolved/fine-dispersed compressed gas flows through an inlet channel 56 of the connecting piece 54 into a valve chamber 57, in which a metering piston 58 engages and forms a seal orthogonally to the longitudinal axis of the connecting piece 54. The metering piston 58 is arranged with infinitely variable stroke adjustment in direction A or alternatively B and is separated in a liquid and gas-tight manner from a valve outlet chamber 61 and from the valve head space 62 by means of seals 59, 60.

The valve chamber 57 is configured as a cylindrical annular space, which is delimited circumferentially on one side by the inner wall of the housing 55 and on the other side by the outer lateral surface of the metering piston 58.

During the stroke in direction B or A of the metering piston 58, the dough or the paste that is in thermodynamic quasi-equilibrium state with regard to gas dispersion/gas dissolution, and which fills the cylindrical valve chamber 57, is transferred from this cylindrical valve chamber into the annular gap 63, which is freed up between the lower end of the metering piston 58 and the annular lower seal 60 configured as a metering piston seal, into the valve outlet chamber 61 and from there further through the valve outlet channel 65 into the environment, for example, into a baking mold. The reference sign 59 designates a seal and 62 designates a valve head space. This is favored in that, when the valve is closed, the lower end of the cylindrical metering piston 58 projects into the valve outlet chamber 61 until the end stop, wherein with the likewise cylindrical valve outlet chamber 61, a narrow annular gap of, for example, ≤2 mm is formed, and upon opening of the valve by a relatively small stroke of the metering piston 58, a narrow flow gap of ≤2 mm is formed, which generates an inwardly directed radial flow, and the valve outlet channel 65 measuring preferably, for example, ≤15 mm and having a diameter of, for example, between ≤3 and 5 mm is kept as short and narrow as possible, but is in principle adapted to the dough viscosity, which is to say, in a recipe-specific manner. For this purpose, the relevant component can be exchangeable.

This adaptation according to the invention of the device is carried out in order to prevent a rupture of the metered dough or paste strand when a supercritical volume expansion rate in relation to the surrounding atmosphere is reached.

In a particular embodiment of the metering piston 58 according to the invention, the metering piston has a cylindrical projection 66 projecting into the valve outlet channel 65, which keeps the flow cross-section in this channel narrowed until shortly before its end and, in the metering position, forms an annular, relatively small cylindrical expansion chamber at the end of the valve outlet channel. The projection 66 is assigned with the end face 64 of the metering piston 58 and, in the embodiment shown, is functionally or materially connected in a unitary manner to the metering piston 58 and, in the embodiment shown, configured in a more or less needle shape, but may also correspond to another embodiment. Overall, the reference sign 67 denotes a valve nozzle tip or a valve nozzle end.

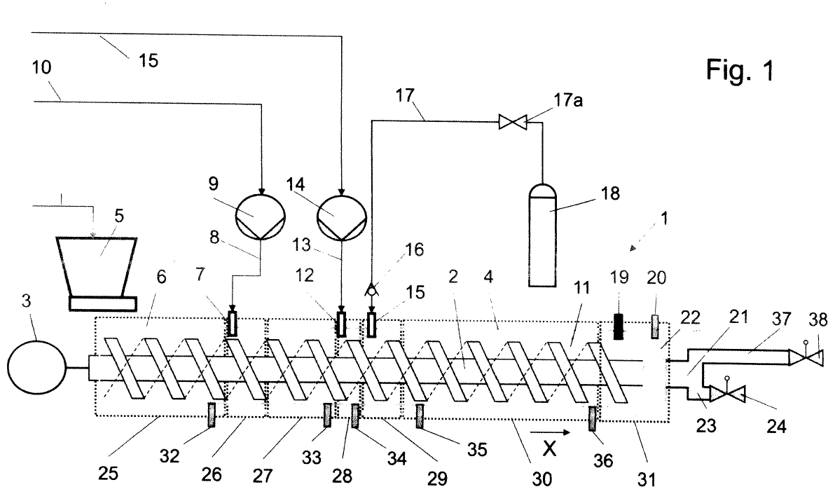

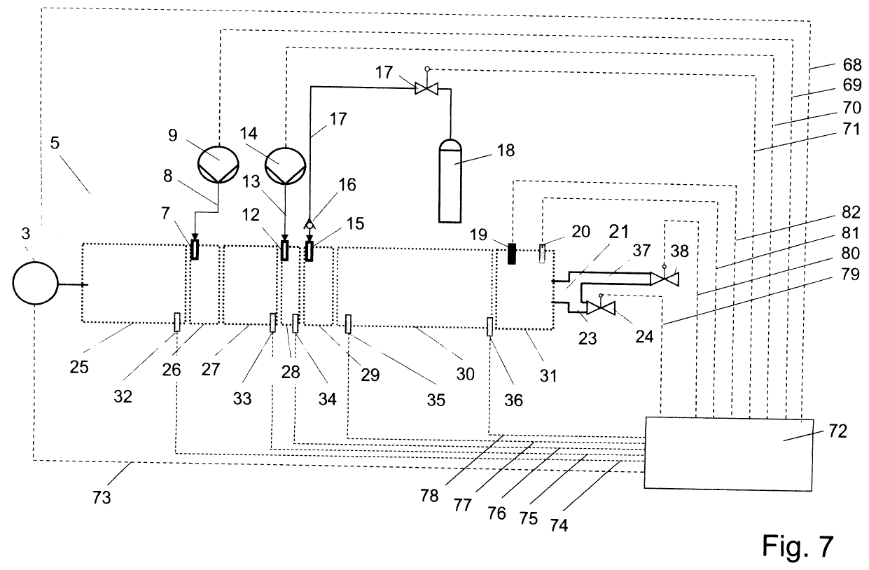

FIG. 7 shows a circuit diagram for the system according to FIG. 1. Reference signs 68 through 71 and 73 through 82 denote signal lines that lead to the individual sensors, to the valves, the metering element on hopper 5, the compressed gas source 18 or the screw drive motor 3 of the system.

The reference sign 72 designates a central data processing system with a control and/or regulation system, for example, a computer unit with data memory, in which data for various recipes, which is to say, baking mixtures, and the respective fluid quantities to be added are also recorded in a recipe-specific manner and can be called up, in particular digitally, for the various dough or paste compositions and dough or paste quantities.

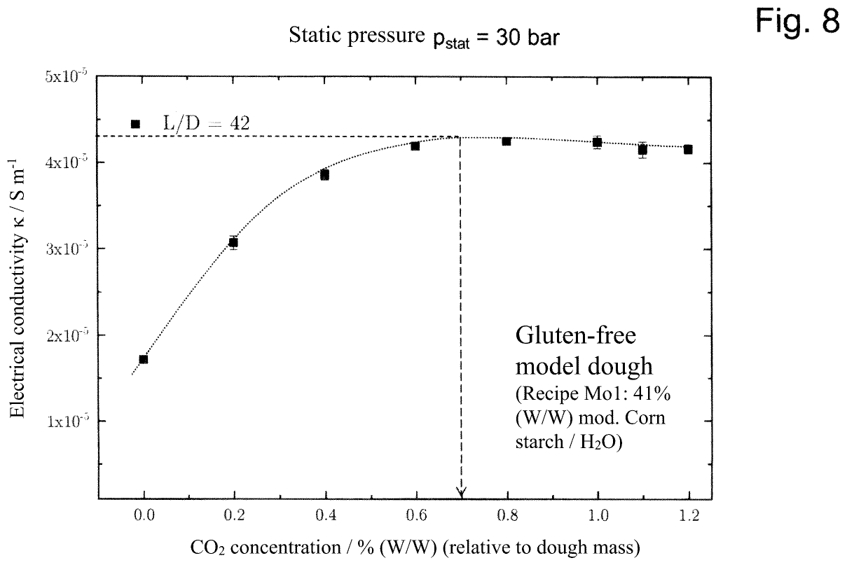

FIG. 8 shows a measurement characteristic of the measuring device 19 configured as a conductivity sensor, for example, for the use of CO₂ as foaming gas to be supplied to the dough or paste in apparatus 1. For the example of a gluten-free model dough, the conductivity increase of approximately a factor of 3 can be derived between a percentage of zero and 0.7 percent by weight of added and dissolved CO₂. From this, it follows that below this state of equilibrium, which at ambient pressure corresponds to a gas component in the product volume of about 75% and a rising of about 300%, the dissolved gas content can be well measured and controlled with the control apparatus according to the invention beyond the typical measure for gas fractions in foamed food/dough or paste systems.

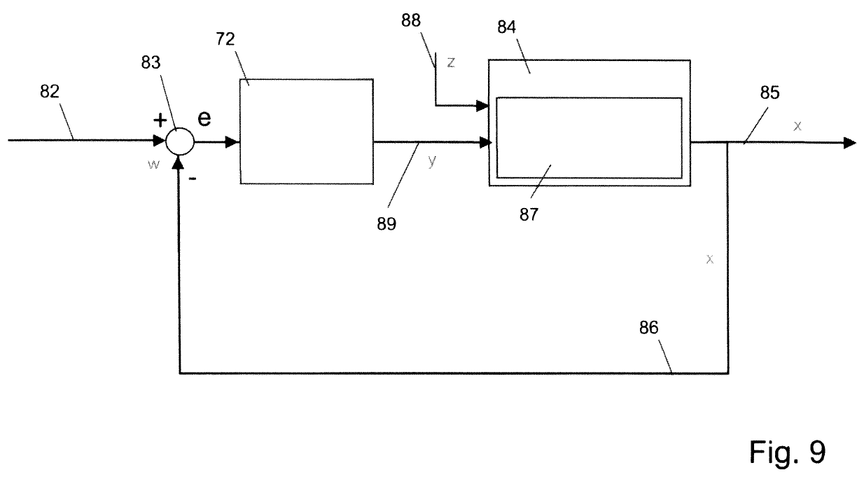

FIG. 9 shows the control circuit diagram as a block diagram for a feedback control of the system shown in FIG. 1. The conductivity k of the dough measured by the measuring device 19 is the preferred controlled variable x, which is adjusted at 83 to a reference value w 82, which corresponds to a recipe-specific dispersed/dissolved gas concentration c*_{GAS,1} in the paste/dough system, which in quasi-equilibrium adjusts under the correspondingly applicable static pressure p_{stat,1} after specific dwell time t_{V,1} and specific gas concentration c_{GAS} in the well-mixed/dispersed fluid-gas system at a specific temperature. In accordance with the invention and the dough recipe, the process temperature is preferably kept constant at a value between 40 and 60° C.

According to the invention, the corresponding relationship k=f (p_{stat,1}, t_{V,1}, c_{CO2}) is determined in laboratory tests in a high-pressure batch stirred reactor with the corresponding paste/dough system under flow conditions comparable to those prevailing in the gas dispersion and dissolution zone 30 of apparatus 1 (typically twin-screw extruder of specific screw geometry, representative shear rate g._{R}≈200 s⁻¹). Preferably, sufficiently long dwell times of 30 to 200 s are sought in the gas dispersion and dissolution zone 30 to achieve a gas dispersion/dissolution state of equilibrium. For this case, equilibrium functions k=f(p_{stat,1}, c_{CO2}), as shown by way of example in FIG. 8, are worked with directly.

The static pressure pₛₜₐₜ₍₃₀₎ to be set in the gas dispersion and dissolution zone 30 serves as control variable y 89 (control variable) for a given gas metering mass flow (dm/dt)_{GAS}. According to the invention, the gas metering pressure p_{GAS} serves as actuator 87 for adjusting pₛₜₐₜ₍₃₀₎ for a specified metered product mass flow (dm/dt)_{Product} and/or the valve opening cross-sections A_{Vi} of the back pressure valve device 24 during start-up of the process or alternatively of the metering valve device 38 during the regular metering process.

The controlled variable x in the control unit 85 is compared with the reference value (setpoint value) in the signal line 82 by means of the feedback loop 86 in the input 83 with the reference value (reference variable w) and the control difference e is supplied to the controller (for example, PLC) that is configured as a data processing system 72, which outputs a defined adjustment of the control variable y 89 according to the control algorithm stored in the PLC. Disturbance variables z 88 as well as further possible actuators 87 affect the output of the control section. The reference variable (reference specification, setpoint) is designated by w. The control deviation e determines, via the control algorithm stored in the control unit 72, the intensity of the resulting action(s) taken via the actuator(s) 87 in the controlled process. The comparison of the current inline measurement value x with the reference value (reference variable w=electrical conductivity for achieving a specific degree of dough foaming here) is denoted by 83.

The disturbance variables z act on the control section 84, and influence a stationary “controlled” operating state. Typical disturbance variables are (a) raw material fluctuations and (b) metering quantity fluctuations.

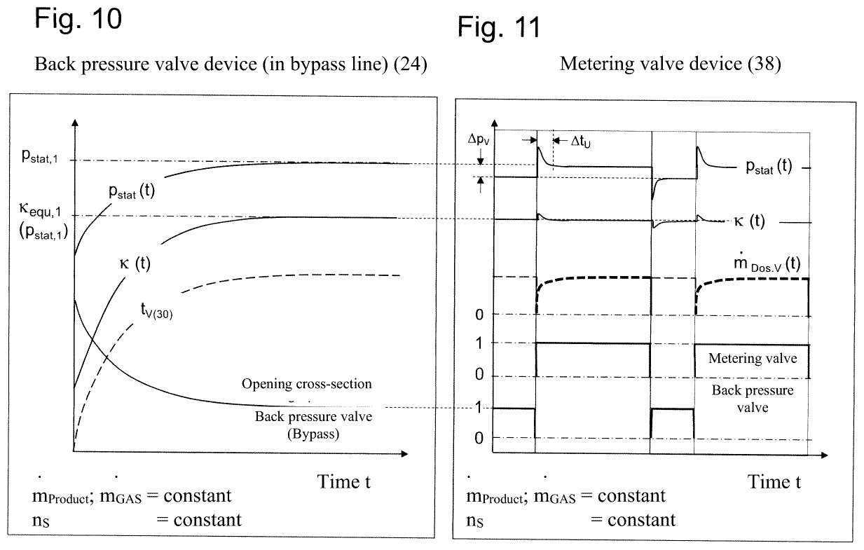

FIG. 10 schematically describes typical temporal characteristics of the physical process parameters during start-up of the process and use of the back pressure valve device 24 in the bypass line 23. The gradual, continuously variable constriction of the high pressure hose 44 in the back pressure valve device causes a correlated increase in the static pressure pₛₜₐₜ₍₃₀₎ in the gas dispersion and dissolution zone 30. A dough and paste system-specific change in the electrical conductivity of the material system follows suit. In the case of increased gas dissolution and dissociation, as in the case of CO₂ as foaming gas, a characteristic increase of the electrical conductivity k occurs. In the case of non-dissociating dissolved or finely dispersed gases, the electrical conductivity is reduced as a rule. Laboratory tests provide quantitative information on this.

FIG. 11 schematically shows the temporal characteristics of the relevant physical process parameters when switching from the back pressure valve device 24 (start-up process) to the metering valve device(s) 38. During start-up by means of back pressure valve device 24, care is taken to ensure that the static pressure pₛₜₐₜ₍₃₀₎ in the gas dispersion and dissolution zone 30 reaches a value by narrowing the valve cross-section, which value, after switching over to metering operation, corresponds to the stationary pressure value during metering operation by means of metering valve device(s) 38, which is to say, a pressure deviation Dp_{V} is negligibly small.

A short-term (<approximately 0.5 s) peak-like increase of pₛₜₐₜ₍₃₀₎ is possible when switching from start-up to metering operation, which, however, decays quickly and is negligible compared to the duration of a metering time interval. Conversely, when switching back from metering to bypass (start-up) operation, a short-term decrease of pₛₜₐₜ₍₃₀₎ is possible. In industrial applications, after completion of a metering cycle of a metering valve device, the system is, as a rule, switched over to a second metering valve device operated in tandem.

As a result of the short-term pressure fluctuations that occur, fluctuations in the controlled variable electrical conductivity k may occur during the switching processes described above, which must be taken into account or compensated for in the control algorithm, for example, by adjusting the measuring time intervals after switching processes.

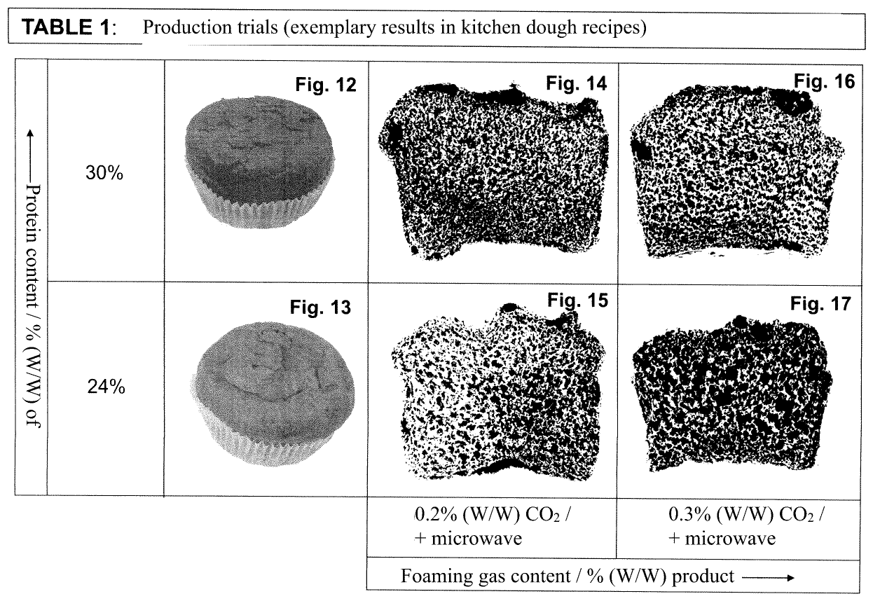

FIG. 12 through FIG. 21 describe examples of foamed dough or paste products produced by the method according to the invention after structure fixation in baking processes.

FIG. 12 through FIG. 17 demonstrate in tabular form (Table 1) for selected exemplary cake batter recipes with variable protein contents, the possibility of influencing the foam structure by means of the protein content of the recipe, as well as by means of the metering of the CO₂ gas quantity. The corresponding recipe components are listed in Table 2.

All these recipes have been successfully prepared by the method according to the invention, however with differing results in terms of the resulting product density and foam structures.

As can be seen in Table 1 (FIG. 12 through FIG. 17), an increased protein content leads to improved stabilization of the microfoam structure with smaller bubble sizes and lowered density (FIG. 14 and FIG. 16). An increase of the foam gas content up to 0.2 g CO₂/100 g product has an ameliorative effect on the foam structure [increased rising=lowered density, small bubble diameters (≤100 micrometers), narrow bubble size distribution span (SPAN≈1.5)]. The case of a further increase of the foaming gas content (FIG. 16 and FIG. 17 with 0.3 g/100 g) results in coarsening of the foam bubbles and loss of volume fraction (approximately 10 to 15%).

TABLE 2
Exemplary processed cake products (recipe/processing data)

| | | | Mass in g/100 g foamed dough product | | | | |
|---|---|---|---|---|---|---|---|
| Recipe | Protein | CO₂ | Sugar | Gluten | Flour | Cocoa | H₂O |
| 1 | 30 | 0.2 | 11 | 4 | 9 | 3 | 43 |
| 2 | 30 | 0.3 | 11 | 4 | 9 | 3 | 43 |
| 3 | 24 | 0.2 | 11 | 4 | 9 | 3 | 49 |
| 4 | 24 | 0.3 | 11 | 4 | 9 | 3 | 49 |

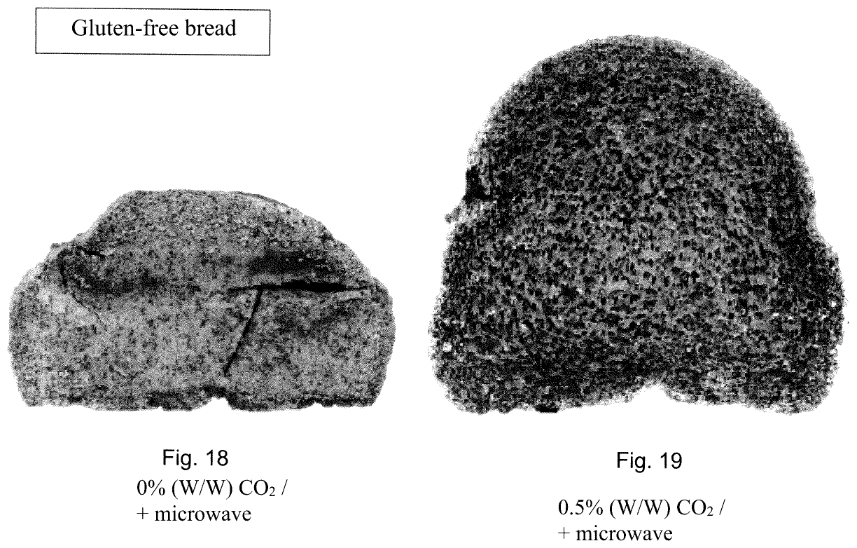

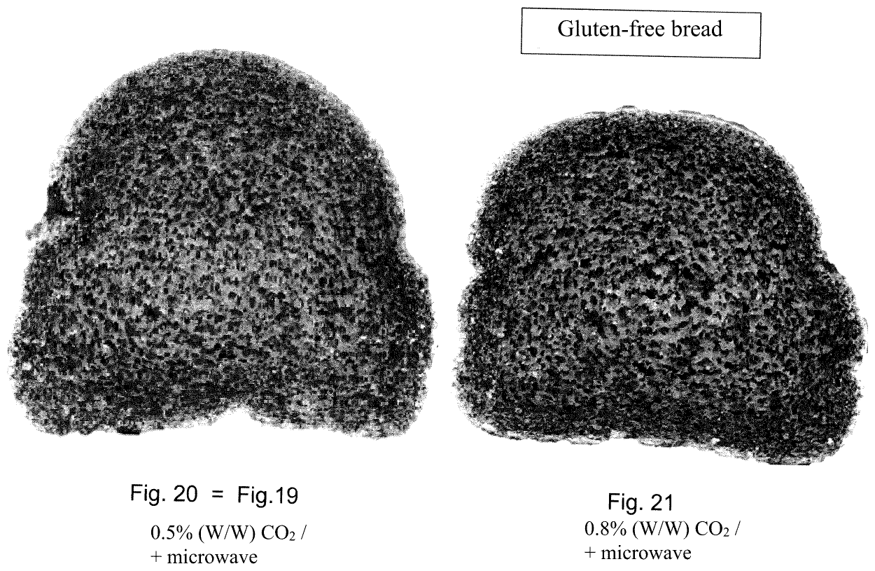

FIG. 18 through FIG. 21 show the internal foam structure comparison for a gluten-free bread recipe with different metering of gas (here CO₂ with 0, 0.5 and 0.8% (W/W) based on the total product mass). FIG. 18 and FIG. 19 clearly show the particular efficiency of the method according to the invention when applied to gluten-free baked goods. The rising (product volume increase due to stably incorporated gas volume fraction) at 0.5% (W/W) metering of gas (based on total mass) increases by a factor of approximately 3 when compared to the non-foamed product of the same recipe. When the foaming gas quantity is over-metered (in this case 0.8% (W/W) CO₂), a larger quantity of gas pores develop which open to the product surface and are connected with one another inside the product, which leads to partial gas outflow and loss of volume of the product.

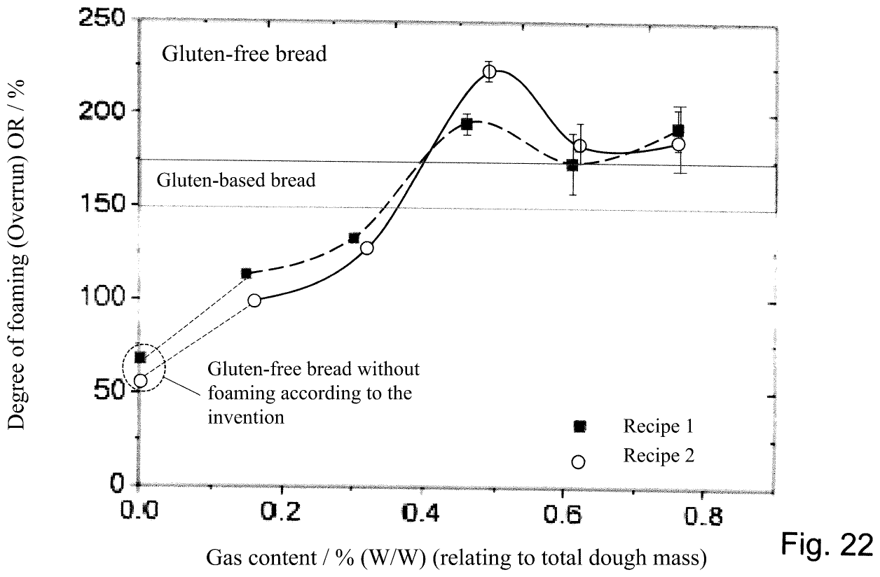

FIG. 22 shows the relationship between the metered gas component and the resulting Overrun (=volume increase share compared to the pure dough fluid volume) after the baking process (end product) with intermediate steps for the gas metering quantity. The measurement values shown correspond to mean values from five analyzed samples. The measurement standard deviations are also shown or alternatively are within the size of the symbols.

The features described in the claims and in the description, as well as those shown in the drawings can be essential for the realization of the invention both individually and in any combination.

1. A method for the combined, continuous mixing and metering of doughs or pastes enriched with gas under static pressure for the manufacture of foamed products, preferably baked goods, more preferably gluten-free baked goods, in which a free-flowing or pourable, dry powder mixture for doughs or pastes with a vegetable protein content in the range from 5 to 70% (W/W), based on the dry substance, is introduced into the elongated process space of a motor-driven extruder in which:
(i) fluid is added by a fluid supply device for the manufacture of a high viscosity dough or paste having a dynamic viscosity of h (g.)≥10 Pas, measured in a rotational rheometer at a shear rate of g.=100 s⁻¹, and thereby a dough or paste plug builds up continuously which seals against backflow effects of fluid or gas,
(ii) the viscosity of the high-viscosity dough or paste plug is reduced by ≥20%, preferably ≥50%, by metering an additional fluid component fraction at least one further fluid supply point which is spaced apart in conveying direction from the first fluid supply device,
(iii) whereinafter a gas component under pressure is supplied and finely dispersed and/or dissolved in the dough or paste fluid phase by a compressed gas supply device arranged in an axial conveying direction, and
(iv) wherein at least one dough or paste discharge and metering element configured as a metering valve device is arranged on the discharge side of the processing space configured as a process space,
(v) the outlet opening of which is regulated or controlled in its cross-section in order to maintain the static pressure required for the gas dissolution in the process space, and wherein
(vi) a measuring device continuously measures the degree of gas dissolution between the compressed gas supply device and the metering valve device
(vii) and due to a pressure control, the gas contained in the dough or paste is kept in solution or fine dispersion until the end of the metering valve device and the foam formation is launched under pressure, lowering only when exiting a valve outlet channel of the metering valve device supported by native starch particles, which particles initiate a secondary, heterogeneous gas bubble nucleation, and
(viii) wherein the subsequent dough or paste foam expansion of at least ≥20% (V/V), supported by the dough or paste viscosity, occurs only after the dough or paste exits the metering valve device.

2. The method according to claim 1, wherein the dough or the paste is transported in one or a plurality of extruders, each extruder having at least one motor-driven extruder screw equipped zonally in different zones with conveying and/or mixing and/or dispersing elements, wherein the extruders are closed gas-tight at both ends during the conveying process, such that no gas loss occurs in the process space by the addition of gas under pressure into the part of the relevant extruder screw channel configured for gas dispersion and/or gas dissolution, and the gas within this partial area of the extruder screw channel is finely dispersed and/or dissolved completely in the dough or in the paste under increased static pressure in a controlled manner and no foam formation is initiated until immediately before the outlet opening of the metering valve device.

3. The method according to claim 2, wherein a free-flowing, dry powder or a free-flowing powder mixture for the production of a dough or a paste is introduced into the extruder screw channel of at least one or a plurality of motor-driven extruder screws and a water- and/or oil-based fluid system is added to this free-flowing powder mixture or the free-flowing powder at the beginning of the extruder screw channel for the production of a high-viscosity dough or a high-viscosity paste with a dynamic viscosity of h (g.)≥10 Pas, measured in a rotational rheometer at a shear rate of g.=100 s⁻¹, which is used as a fluid- and gas-tight sealing plug in the front area of the extruder screw channel, and at a distance therefrom, in the extruder screw channel, a further portion of a water- and/or oil-based fluid system is added to this to produce a diluted, low-viscosity dough or a low-viscosity paste with a dynamic viscosity reduced by ≥20%, and gas is subsequently added under pressure to this low-viscosity dough or this low-viscosity paste, and this gas is converted, under superimposed shear in the extruder screw channel in the gap in thin flow layers produced between co-rotating screw conveyors into a solution or alternatively a microdispersion state with gas bubbles in the diameter range ≤10 micrometers, in the dough or paste system, as well as while avoiding foam formation, this solution/dispersion state is maintained until bubble nucleation is specifically initiated and increased in the gas-containing dough or in the gas-containing paste shortly before discharge from one or more discharge/metering devices by secondary, heterogeneous gas bubble nucleation and pressure reduction.

4. The method according to claim 1 wherein the control of the fluid supply at the two or more fluid supply devices in the extruder screw channel is carried out as a function of the viscosity of the dough or the paste, wherein in a mixing zone sealing conditions, against fluid and gas backflows from the fluid supply zone-2 downstream in the flow direction from the mixing zone and the compressed gas supply zone, are implemented by the formation of a dough or paste plug of higher dynamic viscosity of h (g.)≥10 Pas, measured in a rotational rheometer at a shear rate of g.=100 s⁻¹, which dynamically seals the extruder screw channel, and by this dynamic sealing, static pressures between 5 to 100 bar are provided in the gas dispersion and dissolution zone, and thereby gas dissolution and/or micro-dispersion conditions are provided for the gas phase in the dough or in the paste with dwell times in this gas dispersion and dissolution zone between 10 to 120 seconds, preferably between 30 to 60 seconds, wherein the axial distance between the fluid supply devices is continuously adjusted and the fluid supply devices are locked in predetermined positions, positions matched to the dough or paste recipe, and the gas-enriched dough or the paste with ≥10% (V/V) based on the relaxed state under atmospheric pressure is discharged in a container, a pouring or baking mold, a package or on a conveyor belt via one or more discharge/dosing elements configured as a metering valve device, wherein a static pressure control/pressure conduction brings about the adjustment of the degree of gas microdispersion and/or gas dissolution in the dough or in the paste, as well as for the dissolved gas portion, the gas bubble nucleation and the initiation of bubble expansion is relocated to the outlet end of the discharge/metering elements configured as the metering valve device and the further bubble expansion and foam formation are carried out at least ≥20% in the already metered dough or in the paste, with which a fluidically undisturbed, spatially uniform gas bubble expansion with resulting narrow bubble size distribution is described by SPAN values (SPAN=(x_{90.3}-x_{10.3})/x_{50.3},) for the metered, foamed dough or the paste in the range of ≤1.5, and foam bubble diameter or pore diameter x_{50.3} from 4 to 200 micrometers, for the extruded foamed dough or paste, and from 10 to 250, for the product produced from foamed dough or paste by post-treatment in baking processes, and wherein one or more of the following system parameters are used as control variables for the control of the mean bubble/porous diameters (x50.3) as well as their size distribution width:
(a) dough or paste viscosity,
(b) number density of bubble nucleation nucleator particles added to the dough system,
(c) dough or paste mass flow,
(d) total mass-related gas component added,
(e) rotational speed of the extruder screw,
(f) Opening cross-sectional areas of the metering valves, which, as a function of (a) to (e), define the spatial and temporal pressure relief gradients, wherein the pressure relief gradients directly correlate with the corresponding spatial and temporal gas bubble nucleation and expansion gradients.

5. The method according to claim 1 wherein the supply of a water- and/or oil-based fluid system and gas is adjusted in a controlled or regulated manner as a function of the dough or paste recipe, wherein the first fluid metering takes place by means of the fluid supply device-1 at an axial extruder screw length L, measured in conveying direction, which corresponds to 2 to 8 times the extruder screw diameter D, and in that the second fluid metering is applied by means of the fluid supply device-2 at an axial extruder screw length, measured in conveying direction, which corresponds to at least 10 to 14 times the extruder screw diameter, and wherein the metering of the foaming gas takes place by means of the compressed gas supply device in the form of CO₂ or N₂ or N₂O₂ or air or mixtures thereof under a static pressure of 5 to 100 bar, with a gas volume fraction of between 5 and 70% by volume, based on the pressure-relieved ambient state of the dough or alternatively the paste, in the extruder at an axial extruder screw length, which corresponds to at least 12 to 16 times the extruder screw diameter, whereas for the length range of the gas dispersion and dissolution zone at least 12 L/D<20, when using an extruder with a total length of 28 D applies, whereas this and all previously specified L/D length scales with the factor (L/D)ₘₐₓ/28 are multiplied when using an extruder with (L/D)ₘₐₓ that is other than 28.

6. The method according to claim 1 wherein the process is carried out at a temperature below 160° C., and the foamed dough or paste after discharge into a container, pouring or baking mold, a packaging means or on a conveyor belt is either baked by means of a convection baking process or a combined microwave-convection baking process or is cooled or frozen in a freshly extruded or partially baked state.

7. A control and/or regulating device performing the method according to claim 1, with one or more motor-driven extruder screws, which are supplied by a powder or bulk material metering device configured as a hopper with a discharge element, wherein in a fluid supply zone-1 a free-flowing dough or paste or powder mixture is supplied by means of fluid supply device-1 with a recipe-specific quantity of a water- and/or oil-based liquid in order to achieve, in a downstream mixing zone, a dough or a paste of a higher dynamic viscosity of h₁ (g.)≥10 Pas, measured in a rotational rheometer at a shear rate of g.=100 s⁻¹ h1, and wherein this dough or this paste is metered, in a recipe-specific manner, in a fluid supply zone-2 by means of fluid supply device-2 with an additional amount of fluid, in order to adjust the dough or the paste at a specific viscosity h₂<h₁ reduced by ≥10, and wherein gas is subsequently metered, in a controlled manner, in a compressed gas supply zone by means of a compressed gas supply device that is upstream at an axial distance from the fluid supply device-2 under pressure, in order to achieve a reduced density in the final product through foam formation, wherein the introduced gas is subsequently dissolved or homogeneously microdispersed under a controlled, static pressure between 5 and 100 bar, whereas a sensor measuring the electrical conductivity determines the degree of dissolution or alternatively microdispersion of this gas in the aqueous dough or paste phase, in order to indicate the degree to which an equilibrium value of the gas dissolution/microdispersion is achieved during a predetermined dough or paste dwell time at the end of the gas dispersion and dissolution zone VI in the region of the device designated as gas dissolution measuring and extruder outlet zone VII, wherein based upon this measurement, the controlled adjustment of the proportion of dispersed or alternatively dissolved gas is achieved by means of a feedback loop control using actuators, which are either a back pressure valve device configured as a bypass back pressure valve in a preparation phase of the metering process or at least one metering valve device in the activated metering phase of the process, and wherein the degree of opening of these valves determines the static pressure in the gas dispersion and dissolution zone VI, and thereby controls the dispersion and/or dissolution kinetics and the proportions of the dissolved or microdispersed gas or alternatively gas mixture in the dough or in the paste, which is confirmed by achieving an appropriately measured in-line conductivity value k.

8. The control and/or regulating device according to claim 7, wherein the controlled adjustment of the dough or paste shear viscosity:
takes place in the fluid supply zone-1 to a value of 10≤h₁<1000 Pas, which ensures sealing upstream by the dough or paste in the extruder screw channel against gas or fluid backflow from fluid supply zone-2 IV or the compressed gas supply zone V, wherein the viscosity h₁ takes into account the non-Newtonian flow behavior of the dough by referring to a representative shear rate of 100 s⁻¹, which acts in the mixing zone III and wherein the related viscosity function h(g.) is determined offline by dough or paste rheometry, by means of high pressure capillary rheometer or rotational rheometry; and
takes place in the fluid supply zone-2 to a value of 1 Pas≤h₂<20 Pas, and in the thereby viscosity-reduced fluid dough or paste phase compared to h₁, after the compressed gas supply in the compressed gas supply zone in the gas dispersion and dissolution zone VI arranged downstream of the latter, gas is microdispersed and/or dissolved in the compressed gas supply zone within a dwell time of 30 to 300 s, in order to achieve a degree of foaming in the end product, expressed as the gas volume fraction f_{G,v} of the total product volume, in the range 10≤f_{G,v}<75% (V/V), and connected therewith a correspondingly reduced density in the final product, wherein the viscosity h₂ takes into account the non-Newtonian flow behavior of the dough or of the paste by relating to a representative shear rate of 200 s⁻¹ which acts in the gas dispersion and dissolution zone VI, wherein the related viscosity function h(g.) offline is determined by means of high pressure capillary rheometry or rotational rheometry.

9. The control and/or regulating device according to claim 7 wherein the adjustment of the static pressure in the gas dispersion and dissolution zone VI is carried out as a function of the electrical conductivity value k measured in the subsequent gas dissolution measuring and extruder outlet zone VII, wherein the degree of attainment of a pressure-dependent equilibrium value for the electrical conductivity k_{equ} (pₛₜₐₜ.) is a measure of the degree of gas-dough mass transfer achieved during the dough or paste dwell time in the extruder screw channel within the gas dispersion and dissolution zone VI, and thereby the concentration of the dispersed and/or dissolved gas in the dough or in the paste c_{GAS} is adjusted in a recipe-specific manner in accordance with the conductivity value k measured in-line, wherein the relevant combination of dwell time t_{V(30)} or dough or alternatively paste volume flow (dV/dt)_{Product} and static pressure pₛₜₐₜ₍₃₀₎ in the gas dispersion and dissolution zone VI is adjusted on the basis of a calibration function k=f(pₛₜₐₜ₍₃₀₎, tv), which is determined in a preliminary test by means of extruder/back pressure valve device coupling, and wherein the static pressure Pₛₜₐₜ₍₃₀₎ at the end of gas dispersion and dissolution zone VI, as well as the electrical conductivity k in of the subsequent gas dissolution measuring and extruder outlet zone VII are determined in this preliminary test, while varying the free cross-sectional flow area A_{GDV} in the back pressure valve device for a selected rotational speed n_{S} of the extruder screw and dough or paste mass flow (dm/dt)_{Product}, from which transferable combinations of the variables with continuous metering are derived according to the degree of foaming to be achieved in the metered dough and stored in a database for regular process control.

10. The control and/or regulating device according to claim 7 wherein for a given dough or paste mass flow (dm/dt)_{Product} and recipe-related dough or paste viscosity, a feedback loop control is applied with a given electrical conductivity kₛₑₜₚₒᵢₙₜ as reference variable w, wherein the static pressure pₛₜₐₜ₍₃₀₎ in the gas dispersion and dissolution zone VI is integrated as indirect manipulated variable y, and the electrical conductivity k measured in the gas dissolution measuring and extruder outlet zone VII is integrated as a controlled variable, and wherein either a back pressure valve device in a bypass line, or at least one metering valve device, and/or a compressed gas supply device and/or a rotational speed-adjustment apparatus for the rotational speed n_{S} of the extruder screw coupled to the extruder screw drive motor, are used to adjust the static pressure in the gas dispersion and dissolution zone in a defined manner, wherein a back pressure valve device is used in a bypass line in a preparation run to the regular metering process to determine the static pressure pₛₜₐₜ₍₃₀₎ in the gas dispersion and dissolution zone VI, which is achieved under the process conditions set with regard to dough or paste mass flow (dm/dt)_{Product}, gas mass flow (dm/dt)_{Gas} and rotational speed n_{S} of the screw under specification of product recipe and screw geometries, and which degree of gas dissolution or microdispersion (dm/dt)_{Gas(L,D)}/(dm/dt)_{Gas} is determined, measured via the electrical conductivity k[(dm/dt)_{Gas(L,D)}/(dm/dt)_{Gas}], which adjusts in the dwell times t_{V(30)} realized in the gas dispersion and dissolution zone VI, wherein (dm/dt)_{Gas} designates the total mass flow of gas added and (dm/dt)_{Gas(L,D)} designates the mass flow of the dissolved (dm/dt)_{Gas(L)} and the micro-dispersed non-dissolved gas component (dm/dt)_{Gas(D)}, wherein the latter two variables additionally depend on the type of gas used, and wherein, when switching over from this preparatory run carried out in bypass mode with back pressure valve device to the regular metering process, in which one or more connected metering valve devices are activated, these ensure, by adjusting the degree of opening of the metering valves, that the static pressure and the thereby set degree of gas dissolution or gas dispersion in the gas dispersion and dissolution zone VI, measured via the electrical conductivity of the dough or of the paste, are at the same level as in the preparation test run using the back pressure valve device in the bypass line, and that, for the regular course of the metering process, 2n metering valve devices with n=1 to 20, n denoting half the number of metering valve devices used, are alternately metering in two groups with n metering valve devices each, and thereby that the level of static pressure in the gas dispersion and dissolution zone VI remains constant when switching between the two metering valve device half-groups, which are configured in a similar manner with respect to flow pressure losses, apart from negligible short-term pressure fluctuations less than 0.5 s during the switching process.

11. A device for carrying out the method according to claim 1 for the combined, continuous mixing and metering of doughs or pastes enriched with gas under static pressure, for the manufacture of foamed products, in particular, preferably baked goods, more preferably gluten-free baked goods, using one or a plurality of motor-driven extruder screws, each with a feed hopper for free-flowing dry powder or for free-flowing dry bulk material mixtures, at least two fluid supply devices arranged in the longitudinal axial direction of the extruder concerned, by means of which different fluid quantities are supplied to the extruder screw channel in a controlled or regulated manner via valves, a compressed gas supply device via which gas is introduced into the extruder screw channel under pressure of 5 to 100 bar and in measuring or sensor devices assigned to the extruder screw channel in process-specific zones I to VII in the conveying direction, which measure the static pressure or alternatively the static pressure development along the extrusion process space and measure the dissolved or microdispersed gas content in the dough or in a paste after the gas dispersion and dissolution zone VI, as well as a dough or paste discharge back pressure valve element arranged in a bypass line and configured as a back pressure valve device, the outlet cross section of which can be continuously varied to build up a static back pressure in the extruder screw channel by using a flexible high pressure hose the cross section of which can be adjusted by means of two adjusting pistons, as well as at least one metering valve device configured as a dough or paste discharge metering valve element, which has one or more metering nozzles, the latter arranged in groups with nozzle end discharge cross sections that can be exchanged or adjusted to metering pressure, fluid viscosity and metering mass flow.

12. The device according to claim 11, wherein at least one metering valve device configured as a discharge metering valve element, which can be closed by an adjusting piston, which, in the open state of this metering valve device, frees the outlet nozzle cross-section and comprises a cross-sectional flow area A1 all the way to the valve outlet chamber as well as subsequently over a length of 1 mm to 40 mm, in the valve outlet channel, which has a distinctly narrowed flow channel cross-section with cross-sectional area A2, wherein A2≤0.01 to 0.5 A1, and in the metering case, a back pressure of ≥2 bar and further is built up upstream of the metering valve device, which back pressure has an impact all the way into the gas dispersion and dissolution zone, and there achieves a set level of gas dissolution and/or gas microdispersion, as well as a static pressure reduction only takes place in the metering nozzle outlet channel, which reduction leads to gas bubble nucleation and incipient gas bubble expansion, and wherein the outlet cross-section, which can be closed in a sealing manner by means of adjusting pistons, preferably comprises a conically narrowing annular cross-section of the flow channel, wherein the stroke of this adjusting piston is adjustable in a manually or motor-controlled manner and, thereby, with an increased stroke, an annular flow cross-section tapering conically in the cross-sectional area can be released for the dough or paste mass to be metered, wherein the mean cross-sectional flow area of this conical annular channel is variable, preferably continuously adjustable, by a factor of ≤2, over the entire range of the adjustable stroke length of the valve plunger.

13. The device for carrying out the method according to claim 11 wherein an extruder screw channel of a co-rotating twin screw extruder, with a length of L/D=14 to 50 (where L=screw channel length and D=screw diameter) is provided for the regulated pressure build-up and the gas dissolution in the dough or in the paste, and the extruder length is subdivided into seven length segment zones of respective segment length between L/D=2 and L/D=10, equipped with screw elements of different geometry with regard to assigned process-technical functions, and the following process-technical functions are assigned to these seven length segment zones:
Zone I: powder receiving and compression zone; metering and compression of the powder mixture.
Zone II: fluid supply zone-1; first fluid supply.
Zone III: mixing zone; mixing/kneading and formation of a high-viscosity dough or paste plug sealing the extruder screw channel against zones IV and V.
Zone IV: fluid supply zone-2; fluid mixing and reduction of the dough or paste viscosity.
Zone V: compressed gas supply zone; introduction of gas component under static pressure up to 100 bar.
Zone VI: gas dispersion and dissolution zone; microdispersion and/or dissolution of the admixed gas component.
Zone VII: gas dissolution measuring and extruder outlet zone; approach to gas dispersion and/or gas dissolution equilibrium condition, measurement of static pressure and electrical conductivity as well as inlet into bypass or metering nozzle supply lines.
and in accordance with the functional assignments of zones I-VII, the extruder screw is equipped with screw elements which optimally support the assigned functions (i) in terms of flow, (ii) in terms of dwell time and (iii) in terms of power input, wherein, as a function of recipe composition and dough- or paste-system-specific gas dissolution or alternatively dispersion kinetics, a change of the extruder zone lengths (24 to 31) for the aforementioned assigned functions by approximately ±1 to 2 L/D segment lengths takes place in such a way that a state of equilibrium with regard to the micro-gas dispersion and gas dissolution in zone VI is achieved.

14. A product produced according to a method according to claim 1 wherein the product is gluten-free, comprising a non-gluten-containing proportion of plant proteins of between 5 and 70% (W/W), preferably between 5 and 40% (W/W), based on dry substance, and a gas volume fraction in the untreated dough or paste of 0.1 to 0.75, preferably 0.25 to 0.5, and in the post-treated or baked product of 0.2 to 0.9, preferably 0.3 to 0.7, wherein the doughs or alternatively pastes foamed in this way comprise mean foam bubble or alternatively pore diameters x_{50.3} of 4 to 200 micrometers, preferably of 20 to 100 micrometers, as well as characteristic SPAN values ((x_{90.3}−x_{10.3})/x_{50.3} with x_{10.3}, x_{50.3}, x_{90.3} as 10%-, 50%-90% percentiles of bubble or alternatively porous diameter volume distribution) for quantification of the bubble or alternatively porous diameter distribution width of ≤2, preferably ≤1.5, more preferably of ≤1, as well as for the foam structures obtained from such dough or paste systems by post-treatment in baking processes, comprise mean bubble or alternatively pore diameters of x_{50.3}=10 to 250, preferably of 20 to 150 micrometers and resulting SPAN values ≤2.5, preferably ≤1.5, and more preferably of ≤1.

15. The product according to claim 14, comprises a vegetable protein content from 5 to 70% (W/W), preferably from 10 to 50% (W/W), in relation to dry mass, a carbohydrate content from 5 to 70% (W/W), preferably from 10 to 50% (W/W), in relation to dry mass, a dietary fiber/plant fiber content of from 3 to 30% (W/W), preferably from 5 to 15% (W/W), in relation to dry mass, a fat/oil content of from 0 to 30% (W/W), in relation to dry mass, and a native starch content of potato, corn or rice starch of ≥1 to 5% (W/W), in relation to dry mass, wherein the native starch content comprises one of native potato, corn or rice starch or mixtures thereof at the same total percentile content pretreated by means of freezing-thawing cycles to equal total percentages and is effective as a gas bubble nucleator.

16. Use of a foamed, dough or paste-based product, which is produced by the method according to claim 1, as a base for long-life baked goods, including ready-to-eat gluten-free long-life or fresh baked goods, as a base for fresh or pre-baked and subsequently frozen baked goods, in baked form or alternatively, as a result of protein denaturation, in other thermally stabilized form, as a chunky inclusion component in a chocolate confectionery, ice cream or in another dessert product or in a vegetable or meat pie product, and/or as a coating, covering or surface decoration component of products in chocolate confectionery, ice cream, other desserts, cheese/fresh cheese, meat products, meat-based/meatless pies.
